(19) United States
(12) Patent Application Publication
(10) Pub. No.: US 2007/0206286 A1
(43) Pub. Date: Sep. 6, 2007

(54) Optical film, production process thereof, anti-reflection film, polarizing plate and display device

(75) Inventors: Yuuichi Fukushige, Minami-Ashigara-shi (JP); Naohiro Matsunaga, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporartion, Tokyo (JP)

(21) Appl. No.: 11/712,448

(22) Filed: Mar. 1, 2007

(30) Foreign Application Priority Data
Mar. 1, 2006 (JP) 2006-055408

(51) Int. Cl. G02B 1/10

(52) U.S. Cl. 359/580

(57) ABSTRACT

An optical film, which comprises: a transparent support; and at least two layers each containing a cured product on or above the transparent support, wherein the layer to be brought into contact with the surface of the transparent support contains a cured product of a below-described composition (I) and the outermost layer of the optical film is a layer containing a cured product of a below-described composition (II):

Composition (I): a composition comprising: a polyfunctional compound (a) having two or more ethylenically unsaturated groups; at least one of a photo-polymerization initiator and a thermo-polymerization initiator; and metal oxide particles,

Composition (II): a composition comprising: a binder polymer; a polyfunctional compound (b) having two or more ethylenically unsaturated groups; at least one of a photo-polymerization initiator and a thermo-polymerization initiator; and metal oxide particles; production process of the film; and polarizing plate and display device equipped with the antireflection film.

### BACKGROUND OF THE INVENTION

1. Field of the Invention

The present invention relates to an optical film, production process thereof, antireflection film, polarizing plate, and display device.

2. Description of the Related Art

An antireflection film is usually provided on the outermost surface of a display device such as a cathode ray tube display device (CRT), plasma display panel (PDP), electroluminescence display (ELD), or liquid crystal display device (LCD) so as to reduce a reflectance by making use of the principle of optical interference, thereby preventing deterioration in the contrast or reflection of an image due to reflection of external light.

An antireflection film can be prepared by forming a high refractive index layer such as a hard coat layer over a support and then a low refractive index layer with an appropriate thickness over the high refractive index layer. Use of a material having a refractive index as low as possible is desired for the formation of a low refractive index layer. Since an antireflection film is disposed on the outermost surface of a display device, the low refractive index layer, which will be the uppermost layer of the antireflection film, is required to have high scratch resistance. The low refractive index layer having a thickness of around 100 nm must have sufficient film strength and adhesion to an underlying layer in order to have high scratch resistance.

The refractive index of the layer can be reduced, for example, by (1) introduction of a fluorine atom and (2) reduction in density (introduction of voids). These methods however tend to impair the film strength or adhesion and deteriorate the scratch resistance. It is therefore very difficult to accomplish both a low refractive index and high scratch resistance.

There is described a method of introducing a polysiloxane structure in a fluorine-containing polymer to reduce the friction coefficient on the film surface, thereby improving the scratch resistance (refer to JP-A-11-189621, JP-A-11-228631 and JP-A-2000-313709). This technology is effective to some extent for improving the scratch resistance but cannot impart sufficient scratch resistance to a film essentially lacking in film strength and interfacial adhesion.

For the purpose of ensuring scratch resistance, wear resistance and weather resistance on the surface of an antireflection film while maintaining sufficient interfacial adhesion, there is described a technology of forming an antireflection film having a structure composed of at least two coating layers, one of which, that is, a substrate surface layer contains no colloidal silica and the other layer, that is, the upper layer thereof is made of a coated product containing colloidal silica (refer to Japanese Patent No. 3687230). This technology is however not enough for imparting, to the film, various properties (such as refractive index, hardness, fragility, curl properties, internal haze, and surface haze) which an optical film, especially an antireflection film must have.

### SUMMARY OF THE INVENTION

One aspect of the present invention is to provide an optical film having improved scratch resistance, a production process thereof, and an antireflection film having further improved scratch resistance while having a sufficient antireflective property. Another aspect of the present invention is to provide a polarizing plate and a display device each equipped with such an optical film or an antireflection film.

With a view to overcoming the above-described problem, the present inventors have found that the above-described aspects can be accomplished by the optical film and production process thereof, which will be described below, and completed the present invention. The present invention has the following constitution.

(1) An optical film, which comprises:

a transparent support; and

at least two layers each containing a cured product on or above the transparent support, the at least two layers comprising: a layer to be brought into contact with a surface of the transparent support; and an outermost layer of the optical film,

wherein the layer to be brought into contact with the surface of the transparent support contains a cured product of a below-described composition (I) and the outermost layer of the optical film is a layer containing a cured product of a below-described composition (II):

Composition (I): a composition comprising: a polyfunctional compound (a) having two or more ethylenically unsaturated groups; at least one of a photo-polymerization initiator and a thermo-polymerization initiator; and metal oxide particles,

Composition (II): a composition comprising: a binder polymer; a polyfunctional compound (b) having two or more ethylenically unsaturated groups; at least one of a photo-polymerization initiator and a thermo-polymerization initiator; and metal oxide particles.

(2) The optical film as described in (1) above,

wherein the metal oxide particles are at least one kind of particles selected from the group consisting of particles made of silicon dioxide, particles made of tin oxide, particles made of indium oxide, particles made of zinc oxide, particles made of zirconium oxide and particles made of titanium oxide.

(3) The optical film as described in (1) or (2) above,

wherein the metal oxide particles are aggregating particles, colloidal particles or hollow particles.

(4) The optical film as described in any of (1) to (3) above,

wherein the particles made of silicon dioxide are aggregating silica particles or colloidal silica particles.

(5) The optical film as described in any of (1) to (4) above,

wherein the metal oxide particles have conductivity.

(6) The optical film as described in any of (1) to (5) above,

wherein the metal oxide particles have a particle size of 1 nm or greater but not greater than 1 μm.

(7) The optical film as described in any of (1) to (6) above,

wherein the metal oxide particles are surface-modified with a compound having hydrolyzable silicon.

(8) The optical film as described in any of (1) to (7) above,

wherein the binder polymer is at least one of a heat curable fluorine-containing polymer and an ionizing-radiation curable fluorine-containing polymer.

(9) The optical film as described in any of (1) to (8) above,

wherein at least one of the composition (I) and the composition (II) further comprises light transmitting resin particles having an average particle diameter in a range of from 1 nm to 15 μm.

(10) The optical film as described in any of (1) to (9) above,

wherein the polyfunctional compound (b) in the composition (II) is at least one of a hydrolysate of an organosilane and a partial condensate thereof.

(11) An antireflection film which is an optical film as described in any of (1) to (10) above having an antireflective function.

(12) A polarizing plate, which comprises:

a pair of protective films; and

a polarization film between the pair of protective films,

wherein at least one of the pair of protective films is an optical film as described in any of (1) to (10) above or an antireflection film as described in (11) above.

(13) A display device, which comprises at least one of an optical film as described in any of (1) to (10) above, an antireflection film as described in (11) above and a polarizing plate as described in (12) above,

wherein the layer of the optical film, the antireflection film or the polarizing plate containing the cured product of the composition (II) is disposed on a viewer side.

(14) A process for producing an optical film comprising a transparent support and at least two layers each containing a cured product on or above the transparent support, the process comprising:

applying a below-described composition (I) to the transparent support as a layer to be brought into contact with a surface of the transparent support;

drying and then curing the composition (I) by at least one of a heating and an exposure to ionizing radiation in an atmosphere having an oxygen concentration of 3 vol. % or less; and

applying a below-described composition (II) as an outermost layer of the optical film;

drying and then curing the composition (II) by at least one of a heating and an exposure to ionizing radiation in an atmosphere having an oxygen concentration of 3 vol. % or less:

Composition (I): a composition comprising: a polyfunctional compound (a) having two or more ethylenically unsaturated groups; at least one of a photo-polymerization initiator and a thermo-polymerization initiator; and metal oxide particles,

Composition (II): a composition comprising: a binder polymer; a polyfunctional compound (b) having two or more ethylenically unsaturated groups; at least one of a photo-polymerization initiator and a thermo-polymerization initiator; and metal oxide particles.

### BRIEF DESCRIPTION OF THE DRAWINGS

FIG. 1 is a schematic cross-sectional view illustrating a preferred exemplary embodiment of an antireflection film according to an aspect of the invention;

FIG. 2 is a schematic cross-sectional view illustrating another preferred exemplary embodiment of an antireflection film according to an aspect of the invention;

FIG. 3 is a schematic cross-sectional view illustrating a further preferred exemplary embodiment of an antireflection film according to an aspect of the invention;

FIG. 4 is a schematic cross-sectional view illustrating a preferred exemplary embodiment of an antireflection film having an antiglare hard coat layer according to an aspect of the invention; and

FIG. 5 is a schematic cross-sectional view of another preferred exemplary embodiment of an antireflection film having an antiglare hard coat layer according to an aspect of the invention.

### DETAILED DESCRIPTION OF THE INVENTION

The present invention will hereinafter be described specifically. The description “(numeral 1)-(numeral 2)” as used herein means “(numeral 1) or greater but not greater than (numeral 2)” when the numerals stand for a physical property value or characteristic value. The term “polymerization” as used herein embraces copolymerization. The “surface of a support” or “over a support” as used herein means both the direct surface of the support and the surface of the support having some layer (film) formed thereon.

The optical film of the present invention is an optical film having at least two layers containing cured products on a transparent support, wherein the layer to be brought into contact with the transparent support contains a cured product of the below-described composition (I) and the outermost layer of the optical film is a layer containing a cured product of the below-described composition (II):

Composition (I): a composition having a polyfunctional compound (a) having two or more ethylenically unsaturated groups, a photo- and/or thermo-polymerization initiator and metal oxide particles.

Composition (II): a composition having a binder polymer, a polyfunctional compound (b) having two or more ethylenically unsaturated groups, a photo- and/or thermo-polymerization initiator and metal oxide particles.

It is preferred that the layer containing the cured product of the composition (I) is a hard coat layer and the layer containing the cured product of the composition (II) is a low refractive index layer.

The optical film of the present invention is used preferably as an antireflection film.

### <Antireflection Film>

The optical film of the present invention has at least two layers containing cured products. When the outermost layer of the optical film is an antireflection layer, the optical film of the present invention has a function as an antireflection film.

### [Layer Constitution of Antireflection Film]

The antireflection film of the invention has, over a transparent support (which may be called “substrate” or “substrate film”) thereof, a hard coat layer which will be described later and one or more antireflection layers stacked over the hard coat layer in consideration of a refractive index, film thickness, the number of layers and the order of the layers in order to reduce the reflectance by optical interference. The simplest constitution of the antireflection layer is preferably a combination of a hard coat layer having a refractive index higher than that of a substrate film and a low refractive index layer having a refractive index lower than that of the substrate. Examples of the constitution include an antireflection film having a hard coat layer formed over a substrate film and a low refractive index layer disposed on the hard coat layer; an antireflection film having a hard coat layer formed over a substrate film and then two layers, that is, high refractive index layer and low refractive index layer disposed on the hard coat layer; and an antireflection film having, over a hard coat layer, three layers different in refractive index stacked in the order of medium refractive index layer (a layer having a refractive index higher than that of the substrate film or hard coat layer but lower than that of the high refractive index layer), high refractive index layer and low refractive index layer. Antireflection films having a stack of more antireflection layers have so far been proposed. The antireflection film of the present invention may have a functional layer such as antiglare layer or antistatic layer.

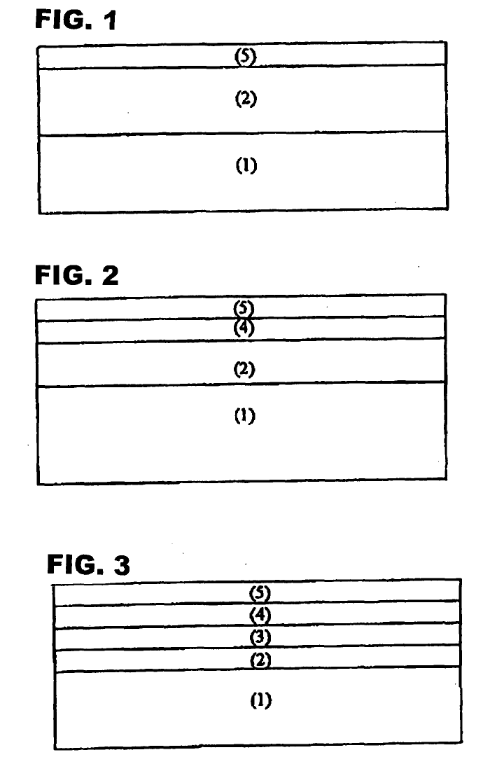

The following are examples of preferred constitution of the antireflection film of the present invention. Their schematic views are shown in FIGS. 1 to 5.

(a): transparent support/hard coat layer/low refractive index layer (FIG. 1)
(b): transparent support/hard coat layer/antiglare layer/low refractive index layer (FIG. 2)
(c): transparent support/hard coat layer/high refractive index layer/low refractive index layer (FIG. 2)
(d): transparent support/hard coat layer/medium refractive index layer/high refractive index layer/low refractive index layer (FIG. 3)
(e): transparent support/antistatic layer/hard coat layer/medium refractive index layer/high refractive index layer/low refractive index layer
(f): antistatic layer/transparent support/hard coat layer/medium refractive index layer/high refractive index layer/low refractive index layer

A film obtained by forming a hard coat layer (2) over a transparent support (1) by application and then stacking a low refractive index layer (5) over the hard coat layer as the above-described constitution (a) (FIG. 1) can be used preferably as an antireflection film. The low refractive index layer (5) formed with a thickness about ¼ of the wavelength of light over the hard coat layer (2) can reduce the surface reflection based on the principle of thin film interference.

A film obtained by forming a hard coat layer (2) over a transparent support (1) by application and then successively stacking a high refractive index layer (4) and a low refractive index layer (5) over the hard coat layer as the above-described constitution (c) (FIG. 2) can be used preferably as an antireflection film. When an antireflection film has a layer constitution obtained by stacking, over a transparent support (1), a hard coat layer (2), a medium refractive index layer (3), a high refractive index layer (4) and a low refractive index layer (5) in the order of mention as (d) (FIG. 3), its reflectance can be reduced to 1% or less.

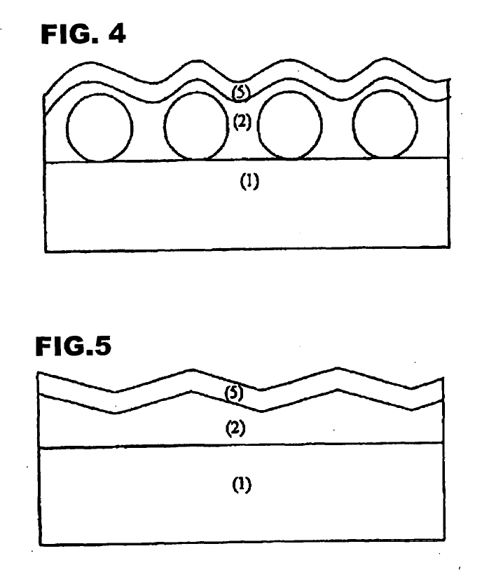

In the layer constitutions (a) to (f) of the antireflection film, the hard coat layer (2) may be an antiglare hard coat layer, that is, a hard coat layer having an antiglare property. The antiglare property may be imparted to the hard coat layer by dispersing therein matting particles as illustrated in FIG. 4 or shaping of the surface by embossment or the like as illustrated in FIG. 5. The antiglare hard coat layer formed by the dispersion therein of matting particles is composed of a binder and light transmitting particles dispersed in the binder. The antiglare hard coat layer has both an antiglare property and a hard coat property. The hard coat layer may be composed of a plurality of layers such as an antiglare hard coat layer and a flat hard coat layer. Alternatively, an antiglare layer may be disposed separately from the hard coat layer.

Examples of a layer which may be disposed between the support and a layer on the surface side thereof or disposed on the outermost surface include a layer preventing interference unevenness (rainbow-like unevenness), an antistatic layer (when surface resistance must be reduced from the display side or when dust attached to the surface poses a problem), another hard coat layer (when a single hard coat layer or antiglare hard coat layer cannot provide sufficient hardness), a gas barrier layer, a water absorption layer (moisture proof layer), adhesion improving layer, and antifouling layer (contamination preventing layer).

Refractive indexes of the layers constituting the antireflection film having an antireflective layer in the invention preferably satisfy the following relationship:

Refractive index of hard coat layer>refractive index of transparent support>refractive index of low refractive index layer

The layer constitution of the antireflection film of the invention is not particularly limited to the above-described ones insofar as the reflectance of the film can be reduced by making use of optical interference.

The high refractive index layer may be an optical diffusive layer having no antiglare property. The antistatic layer preferably contains conductive polymer particles or fine metal oxide particles (such as SnO₂ and ITO) and it can be formed by the application process or atmospheric plasma treatment.

### [Hard Coat Layer]

The antireflection film of the present invention has a hard coat layer over a transparent support and it has further a low refractive index layer over the hard coat layer. The antireflection film may have, as the hard coat layer, an antiglare hard coat layer, though depending on the required performance. The antireflection film may have, below the antiglare hard coat layer, a hard coat layer having no antiglare property for the purpose of improving the film strength.

The total film thickness of the hard coat layer is preferably from 1 to 40 μm from the standpoints of scratch resistance, fragility and film curl.

The composition (I) of the invention will next be described. The composition (I) contains a polyfunctional compound (a) having two or more ethylenically unsaturated groups, a photo- and/or thermo-polymerization initiator, and metal oxide particles.

### [Binder Polymer]

The binder used for the hard coat layer is preferably a polymer having, as a main chain thereof, a saturated hydrocarbon chain or polyether chain, more preferably a polymer having, as a main chain thereof, a saturated hydrocarbon chain. Further, the binder polymer has preferably a crosslinked structure.

### (Binder Polymer Having, as a Main Chain Thereof, a Saturated Hydrocarbon Chain)

As the binder polymer having, as a main chain thereof, a saturated hydrocarbon chain, a polymer of an ethylenically unsaturated monomer is preferred. As the binder polymer having, as a main chain thereof, a saturated hydrocarbon chain and in addition having a crosslinked structure, a (co)polymer of a monomer having two or more ethylenically unsaturated groups is preferred.

In order to increase the refractive index of the layer, it is preferred to incorporate an aromatic ring or at least one atom selected from halogen atoms other than fluorine, a sulfur atom, a phosphorus atom and a nitrogen atom in the structure of the monomer.

Examples of the monomer (polyfunctional compound (a)) having two or more ethylenically unsaturated groups include (meth)acrylate esters of a polyol {for example, ethylene glycol di(meth)acrylate, 1,4-cyclohexanediol di(meth)acrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexanetriol tri(meth)acrylate, polyurethane polyacrylate and polyester polyacrylate}; ethylene oxide modified esters, vinylbenzene and derivatives thereof {for example, 1,4-divinylbenzene, 2-(meth)acryloylethyl 4-vinylbenzoate and 1,4-divinylcylohexanone}; vinyl sulfones (for example, divinylsulfone); and (meth)acrylamides (for example, methylenebisacrylamide). Two or more of these monomers may be used in combination.

Specific examples of the high refractive index monomer include bis(4-methacryloylthiophenyl)sulfide, vinylnaphthalene, vinyl phenyl sulfide, 4-methacryloxyphenyl-4-methoxyphenyl thioether. Two or more of these monomers may be used in combination.

By using, in addition to the monomer having two or more ethylenically unsaturated groups, a monomer having a crosslinkable functional group to introduce the crosslinkable functional group into the polymer and making use of the reaction of this crosslinkable functional group, the crosslinked structure may be introduced into the binder polymer.

Examples of the crosslinkable functional group include isocyanate group, epoxy group, aziridine group, oxazoline group, aldehyde group, carbonyl group, hydrazine group, carboxyl group, methylol group and active methylene group. Vinylsulfonic acid, acid anhydride, cyanoacrylate derivative, melamine, etherified methylol, ester, urethane, and a metal alkoxide such as tetramethoxysilane may also be used as a monomer for introducing the crosslinked structure. A functional group showing a crosslinking property as a result of decomposition reaction such as a block isocyanate group may also be usable. In short, in the invention, the crosslinkable functional group does not necessarily show reactivity immediately but may show reactivity as a result of decomposition.

The binder polymer having such a crosslinkable functional group can form a crosslinked structure by heating after application.

### (Polymerization Initiator)

The polymerization of such an ethylenically-unsaturated-group-containing monomer can be performed by exposure to ionizing radiation or by heating in the presence of a photo radical polymerization initiator or a thermal radical polymerization initiator. Accordingly, the hard coat layer of the antireflection film can be formed by preparing a coating solution containing a monomer having an ethylenically unsaturated monomer, a photo radical or thermal radical initiator, metal oxide particles and if necessary matting particles; applying the resulting coating solution onto a transparent support, and curing it through polymerization reaction by ionizing radiation or heat.

### (Photo Radical Polymerization Initiator)

Examples of the photo radical polymerization initiator include acetophenones, benzoins, benzophenones, phosphine oxides, ketals, anthraquinones, thioxanthones, azo compounds, peroxides (as described in JP-A-2001-139663), 2,3-dialkyldione compounds, disulfide compounds, fluoroamine compounds, aromatic sulfoniums, onium salts, borates and active halogen compounds.

Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone and 2-benzyl-2-dimethylamino-1-(4-morpholinophenyl)-butanone.

Examples of the benzoins include benzoin benzenesulfonate ester, benzoin toluenesulfonate ester, benzoin methyl ether, benzoin ethyl ether and benzoin isopropyl ether.

Examples of the benzophenones include benzophenone, 2,4-dichlorobenzophenone, 4,4-dichlorobenzophenone and p-chlorobenzophenone. Examples of the phosphine oxides include 2,4,6-trimethylbenzoyldiphenylphosphine oxide.

Various examples are also described in Saishin UV Koka Gijutsu (Latest UV Curing Technologies), page 159, published by Kazuhiro Takausu of Technical Information Institute, (1991) and Shigaisen Koka System (Ultraviolet Ray Curing System) on pages 65-148 (written by Kiyoshi Kato, published by Sogo Gijutsu Center (1988)), and these are useful in the invention.

Preferred examples of the commercially available photo radical polymerization initiator of photo-cleavage type include “IRGACUREs (651, 184, 907)” (trade name; product of Nihon Ciba Geigy).

The photopolymerization initiator is used in an amount preferably ranging from 0.1 to 15 parts by mass, more preferably from 1 to 10 parts by mass, per 100 parts by mass of the polyfunctional monomer. (In this specification, mass ratio is equal to weight ratio.)

### (Photosensitizer)

In addition to the photopolymerization initiator, a photosensitizer may be used. Specific examples of the photosensitizer include n-butylamine, triethylamine, tri-n-butylphosphine, Michler's ketone and thioxanthone.

### (Thermal Radical Polymerization Initiator)

As a thermal radical polymerization initiator, organic peroxides, inorganic peroxides, organic azo compounds and organic diazo compounds may be used.

More specifically, examples of the organic peroxide include benzoyl peroxide, halogen benzoyl peroxide, lauroyl peroxide, acetyl peroxide, dibutyl peroxide, cumene hydroperoxide and butyl hydroperoxide; examples of the inorganic peroxide include hydrogen peroxide, ammonium persulfate and potassium persulfate; examples of the azo compound include 2,2′-azobis(isobutyronitrile), 2,2′-azobis(propionitrile) and 1,1′-azobis(cyclohexanedinitrile); and examples of the diazo compound include diazoaminobenzene and p-nitrobenzenediazonium.

### (Binder Polymer Having, as a Main Chain Thereof, Polyether)

The binder polymer having, as a main chain thereof, polyether is preferably a ring-opened polymer of a polyfunctional epoxy compound. The ring-opening polymerization of a polyfunctional epoxy compound may be performed by exposure to ionizing radiation or by heating in the presence of a photoacid generator or a thermal acid generator.

Accordingly, the hard coat layer can be formed by preparing a coating solution containing the polyfunctional epoxy compound, photoacid or thermal acid generator, matting particles and metal oxide particles, applying the coating solution onto a transparent support, and then curing it through a polymerization reaction by the ionizing radiation or heating.

### [Metal Oxide Particles]

Metal oxide particles are preferably added to constituent layers including the hard coat layer formed over the support. The metal oxide particles added to these constituent layers may be the same or different and their kind or amount is adjusted preferably depending on the necessary properties such as refractive index, film strength, film thickness and coating properties.

No particular limitation is imposed on the shape of the metal oxide particles to be used in the invention and for example, any of spherical, sheet-like, fibrous, rod-like, amorphous and hollow particles are preferred.

As specific examples of these particles, particles of an inorganic compound such as silica particles and TiO₂ particles are preferred.

The silica particles may be spherical ones having a primary particle size of 1 nm or greater but not greater than 1 μm. Spherical particles having a primary particle size of 0.5 μm or greater but not greater than 10 μm are also usable, but aggregating silica in which particles having a primary particle size of several tens nm have formed an aggregate is preferred because it can prevent bleaching and stably impart appropriate surface haze to the film.

The aggregating silica can be synthesized by the so-called wet process, that is, by the neutralization reaction between sodium silicate and sulfuric acid, but preparation process is not limited thereto. The wet process can be roughly classified into precipitation process and gelation process, but either process can be adopted in the invention. The secondary particle size of the aggregating silica falls within a range of preferably from 0.01 to 10.0 μm, but is selected in consideration of the thickness of the hard coat layer which will contain the particles.

A value obtained by dividing the secondary particle size of the aggregating silica particles by the thickness of the hard coat layer falls within a range of preferably from 0.1 to 1.0, more preferably from 0.2 to 0.8.

Particles made of silicon dioxide are preferably colloidal silica because it can impart dispersion stability and coating properties.

Although no particular limitation is imposed on the kind of the metal oxide particles, amorphous ones are preferred. They are made of an oxide, nitride, sulfide or halide of a metal, with the oxide of a metal being especially preferred. Examples of the metal atom include Zr, Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb and Ni.

The metal oxide particles are preferably at least one kind of particles selected from particles made of silicon dioxide, particles made of tin oxide, particles made of indium oxide, particles made of zinc oxide, particles made of zirconium oxide, and particles made of titanium oxide and they are preferably aggregating particles, colloidal particles or hollow particles.

The particles made of silicon oxide are preferably aggregating silica particles or colloidal silica particles. The metal oxide particles are also preferably particles having conductivity.

In order to form a transparent cured film, the metal oxide particles have an average particle size of preferably 1 nm or greater but not greater than 1 μm, more preferably 1 nm or greater but not greater than 200 nm, still more preferably 1 μm or greater but not greater than 100 mm, especially preferably 1 nm or greater but not greater than 80 nm. The average particle size of the particles is measured by a Coulter counter.

The metal oxide particles have a surface preferably subjected to silane coupling treatment or titanium coupling treatment. A surface treatment agent having a functional group reactive with the binder species on the surface of the metal oxide particles is preferably employed.

The amount of the metal oxide particles is preferably from 10 to 90%, more preferably from 20 to 80%, especially preferably from 30 to 75%, based on the entire mass of the hard coat layer. The amount of the metal oxide particles can be selected as needed within the above-described range even when they are added to an antiglare hard coat layer or flat hard coat layer which will be described later.

Such metal oxide particles have a particle size sufficiently smaller than the wavelength of light and therefore, causes no scattering, and a dispersion having the particles dispersed in the binder polymer behaves as an optically uniform substance.

No particular limitation is imposed on the using manner of the metal oxide particles in the invention and they can be used in the dry form or as dispersed in water or an organic solvent.

### [Dispersion Stabilizer]

For the purpose of suppressing aggregation or precipitation of the metal oxide particles, it is preferred to use a dispersion stabilizer in combination. Examples of the dispersion stabilizer include polyvinyl alcohol, polyvinylpyrrolidone, cellulose derivatives, polyamides, phosphoric acid esters, polyethers, surfactants, hydrolysates of an organosilane compound and/or partial condensates thereof, silane coupling agents, and titanium coupling agents. Silane coupling agents are especially preferred because they can provide a strong cured film.

Although no particular limitation is imposed on the amount of the silane coupling agent to be added as a dispersion stabilizer, it is added preferably in an amount of 1 part by mass or greater based on 100 parts by mass of the metal oxide particles. In addition, no particular limitation is imposed on the addition manner of the silane coupling agent as the dispersion stabilizer. The silane coupling agent which has been hydrolyzed in advance may be added or the silane coupling agent serving as a dispersion stabilizer may be mixed with the metal oxide particles, followed by hydrolysis and condensation. The latter method is preferred.

As described above, the hydrolysate of an organosilane compound and/or partial condensate thereof may be used as a dispersion stabilizer of the metal oxide particles. It is also usable as a portion of the constituent of the matrix of each layer such as a curable compound contained in a composition for forming a low refractive index layer which will be described later or as an additive upon preparation of a coating solution. Particularly in the invention, use of a hydrolysate of a specific organosilane compound and/or partial condensate thereof for a low refractive index layer is preferred, which will however be described later in detail.

### [Antiglare Hard Coat Layer]

The antiglare hard coat layer preferably used in the invention will next be described. The antiglare hard coat layer is made of a binder for imparting a hard coat property, matting particles for imparting an antiglare property, and metal oxide particles for increasing a refractive index, preventing shrinkage due to crosslinking and enhancing strength.

### (Matting Particles)

The antiglare hard coat layer contains, in order to give an antiglare property to the film, matting particles having an average particle size greater than that of the aggregating silica particles or filler particles and ranges from 1.0 to 10.0 μm, preferably from 1.5 to 7.0 μm, for example, particles of an inorganic compound or light transmitting resin particles.

Specific examples of these particles include particles of an inorganic compound such as silica particles and TiO₂ particles and resin particles such as crosslinked acrylic particles, crosslinked styrene particles, melamine resin particles and benzoguanamine resin particles.

The silica particles may be spherical particles having a primary particle size of from 0.5 to 10 μm. In particular, aggregating silica, in which particles having a primary particle size of several tens nm have formed an aggregate, is preferred because it can prevent bleaching and stably impart appropriate surface haze to the film.

The aggregating silica can be synthesized by the so-called wet process, that is, by the neutralization reaction between sodium silicate and sulfuric acid, but preparation process is not limited thereto. The wet process can be roughly classified into precipitation process and gelation process, but either process can be adopted in the invention. The secondary particle size of the aggregating silica falls within a range of preferably from 0.1 to 10.0 μm, but is selected in consideration of the thickness of the hard coat layer which will contain the particles.

A value obtained by dividing the secondary particle size of the aggregating silica particles by the thickness of the hard coat layer falls within a range of preferably from 0.1 to 1.0, more preferably from 0.3 to 0.8.

The light transmitting resin particles which can be used in combination with the silica particles, preferably aggregating silica particles will next be described specifically.

Specific examples of the light transmitting resin particles usable in combination include poly((meth)acrylate) particles, crosslinked poly((meth)acrylate) particles, polystyrene particles, crosslinked polystyrene particles, crosslinked poly(acryl-styrene) particles, melamine resin particles, and benzoguanamine resin particles. Of these, crosslinked polystyrene particles, crosslinked poly((meth)acrylate) particles, and crosslinked poly(acryl-styrene) particles are preferred, with crosslinked poly((meth)acrylate) particles and crosslinked poly(acryl-styrene) particles being most preferred. An internal haze or surface haze can be adjusted to fall within a desired range by controlling the refractive index or amount of the light transmitting resin in accordance with the refractive index of the light transmitting fine particles selected from these particles.

It is preferable that one or both of the composition (I) and the composition (II) further include light transmitting resin particles having a particle size (average particle diameter) in the range of from 1 nm to 15 μm. An average particle diameter can be measured by Micro Track MT-3000II.

An average particle diameter of the light transmitting resin particle used in combination is more preferably from 0.5 to 10 μm and even more preferably from 2.0 to 9.0 μm when the layer to be added is in the composition (II), and it is more preferably from 1 to 90 nm and even more preferably from 2.0 to 70 nm when the layer to be added is in the composition (I).

As the particle to be included to the compositions (I) and (II), a uniform particle prepared with the use of a micro reactor or the like can be used. (micro reactor; see Kagaku to Kogyo, 59(3),244(2006)) The light transmitting resin particles usable in combination have a compressive strength of preferably from 2.2 to 10.0 kgf/mm², more preferably from 2.5 to 8.0 kgf/mm² in order to improve scratch resistance of the resulting film. Selection of a proper crosslinking agent of increase in the crosslinking degree is effective for heightening the compressive strength of the resin particles.

Matting particles may be either in the true spherical form or amorphous form. Two or more kinds of matting particles may be used in combination.

The matting particles are incorporated in the antiglare hard coat layer so that the amount of the matting particles in the antiglare hard coat layer after its formation will fall within a range of from 10 to 1000 mg/m², more preferably from 30 to 100 mg/m².

In an especially preferred mode, crosslinked styrene particles are used as the matting particles and the crosslinked styrene particles having a particle size greater than half of the thickness of the antiglare hard coat layer amount to from 40 to 100% of the entire crosslinked styrene particles.

The particle size distribution of the matting particles is measured by the Coulter Counter method and the distribution thus measured is converted into particle number distribution.

Also, two or more kinds of matting particles different in the particle size may be used in combination. It is possible to impart an antiglare property by using matting particles having a larger particle size and impart another optical property by using matting particles having a smaller particle size. For example, when an antireflection film is attached to a display device having a definition degree as high as 133 dpi or greater, it is required to cause no glare, that is, a trouble in optical performance. The glare occurs because a picture element is enlarged or reduced due to irregularities slightly present on the film surface and the uniformity of a display performance is lost. This trouble can be overcome largely by using in combination matting particles having a particle size smaller by from 5 to 50% than that of the matting particles for imparting an antiglare property.

The particle size distribution of the matting particles is preferably monodisperse. Individual particles preferably have an equal particle size as much as possible. For example, when a particle having a particle size greater by at least 20% than the average particle size is defined as a coarse particle, the percentage of the coarse particles in the total number of particles is preferably 1% or less, more preferably 0.1% or less, still more preferably 0.01% or less. Matting particles having such a particle size distribution can be obtained by the classification after the ordinary synthesis reaction. By increasing the frequency of classification or intensifying the classification degree, matting particles having a more preferred distribution are available.

### (Metal Oxide Particles)

The antiglare hard coat layer preferably contains, in addition to the matting particles, metal oxide particles made of an oxide of at least one metal selected from titanium, zirconium, aluminum, indium, zinc, tin and antimony and having an average particle size of from 1 nm to 1 μm, more preferably from 1 nm to 200 nm, still more preferably from 1 nm to 100 nm, especially preferably from 1 nm to 80 nm in order to heighten the refractive index of the antiglare hard coat layer.

The antiglare hard coat layer containing high refractive index matting particles for enlarging the difference in refractive index between the hard coat layer and the matting particles preferably uses silicon oxide to keep the refractive index of the hard coat layer at a lower level. The preferable particle size is similar to that of the above-described metal oxide particles.

Specific examples of the metal oxide particles to be incorporated in the antiglare hard coat layer include TiO₂, ZrO₂, Al₂O₃, In₂O₃, ZnO, SnO₂, Sb₂O₃, ITO (indium-tin oxide) and SiO₂. Of these, TiO₂ and ZrO₂ are preferred from the viewpoint of increasing a refractive index. The metal oxide particles have preferably a surface subjected to silane coupling or titanium coupling treatment. A surface treatment agent having a functional group reactive with the binder on the surface of the metal oxide particles is preferably employed.

Because of having a particle size sufficiently smaller than the wavelength of light, such metal oxide particles cause no scattering. Therefore, a dispersion having the metal oxide particles dispersed in the binder polymer behaves as an optically homogeneous substance.

The total refractive index of the mixture of the binder and metal oxide particles contained in the antiglare hard coat layer in the antireflection film of the invention ranges preferably from 1.48 to 2.00, more preferably from 1.50 to 1.80. The refractive index can be adjusted to fall within the above-described range by selecting the kinds of the binder and metal oxide particles or a ratio of their amounts properly. The proper kinds or ratio can be selected based on the results known by experiment in advance.

### (Surfactant)

The antiglare hard coat layer of the invention may contain, in the coating composition for the formation of the antiglare hard coat layer, either one or both of fluorosurfactant and silicone surfactant in order to suppress surface troubles such as coating unevenness, drying unevenness and point defects, thereby ensuring surface evenness. In particular, a fluorine surfactant is preferred because addition of a small amount of it is effective for overcoming such surface troubles of the antireflection film of the invention.

Preferred examples of fluorosurfactants include perfluoroalkyl-containing oligomers such as “MEGAFACE F-171”, “MEGAFACE F-172”, “MEGAFACE F-173”, and “MEGAFACE F-176” (each, trade name; product of Dainippon Ink & Chemicals). Examples of silicone surfactants include polydimethylsiloxanes obtained by modifying a side chain or the terminal of a main chain thereof with various substituents, for example, oligomers such as ethylene glycol and propylene glycol.

Use of such a surfactant, however, sometimes causes segregation of an F-containing functional group and/or Si-containing functional group on the surface of the antiglare hard coat layer, thereby deteriorating the surface energy of the antiglare hard coat layer. Overcoating of the antiglare hard coat layer with a low refractive index layer may deteriorate the antireflective property. This phenomenon is presumed to occur because owing to a reduction in the wettability of the coating solution for forming a low refractive index layer with the surface of the antiglare hard coat layer, irregularities too small to be detected by the visual observation appear in the thickness of the low refractive index layer.

In order to solve the above-described problem, it is effective to adjust the structure or amount of the fluorosurfactant and/or silicone surfactant, thereby controlling the surface energy of the antiglare hard coat layer within a range of preferably from 25 to 70 mN·m⁻¹, more preferably from 35 to 70 mN·m⁻¹. It is more effective, as will be described later, to employ a solvent having a boiling point of 100° C. or less as from 50 to 100 mass % of the coating solvents for forming a low refractive index layer.

Further, in order to realize the above-described surface energy, it is desired to adjust F/C, a ratio of a fluorine-atom-derived peak to a carbon-atom-derived peak, to 0.40 or less and Si/C, a ratio of a silicon-atom-derived peak to a carbon-atom-derived peak to 0.30 or less, each as measured by X-ray photoelectron spectroscopy.

The antiglare hard coat layer has a film thickness of preferably from 1 to 10 μm, more preferably from 1.2 to 6 μm.

### [Flat Hard Coat Layer]

In the antireflection film of the invention, a flat hard coat layer having no antiglare property is preferably employed for the purpose of improving the strength of the film further. The flat hard coat layer is preferably used in combination with the antiglare hard coat layer. In such a case, it is disposed between the transparent support and antiglare hard coat layer.

Materials to be used for the flat hard coat layer are similar to those used for the antiglare hard coat layer except for the matting particles for imparting an antiglare property. The flat hard coat layer is made of a binder and preferably metal oxide particles.

In the flat hard coat layer in the invention, metal oxide particles are preferably silica and alumina particles from the standpoints of strength and versatility, with silica particles being especially preferred. The metal oxide particles have preferably a surface subjected to silane coupling treatment. As a surface treatment agent, that having a functional group reactive with the binder species on the surface of the metal oxide particles is preferred.

The flat hard coat layer has a thickness of preferably from 1 to 10 μm, more preferably from 1.2 to 6 μm.

### [Low Refractive Index Layer]

The low refractive index layer of the antireflection film in the invention will next be described.

In the antireflection film of the invention, the refractive index of the low refractive index layer is preferably from 1.38 to 1.49, more preferably from 1.38 to 1.44.

Furthermore, in order to have a reduced refractive index, the low refractive index layer preferably satisfies the following equation (1):

(jλ/4)×0.7<n₁d₁≦(jλ/4)×1.3 Equation (1):

wherein j is a positive odd number, n₁ is the refractive index of a low refractive index layer, d₁ is the film thickness (nm) of the low refractive index layer, and λ is a wavelength and is a value falling within a range of from 500 to 550 nm. The film thickness (d₁) of the low refractive index layer is preferably from 70 to 150 nm, more preferably from 80 to 120 nm, most preferably from 85 to 115 nm.

When the low refractive index layer satisfies the equation (1), this means that j (a positive odd number, usually 1) satisfying the equation (1) within the above-described wavelength range is present.

The composition (II) of the invention will next be described. The composition (II) contains a binder polymer, a polyfunctional compound (b) having two or more ethylenically unsaturated groups, a photo- and/or thermo-polymerization initiator and metal oxide particles.

The polyfunctional compounds (b), photo- and/or thermo-polymerization initiator and metal oxide particles similar to those employed for the composition (I) can also be employed. The composition (II) is used preferably for the formation of a low refractive index layer.

Materials used for the formation of the low refractive index layer in the invention will next be described.

The low refractive index layer to be used in the invention is made of a composition for forming a low refractive index layer containing a binder polymer, at least one polymerization initiator, metal oxide particles and a curable compound having an ethylenically unsaturated group. It is more preferred that the polymerization initiator and curable compound exist and have been cured locally in the lower portion of the low refractive index layer.

The polymerization initiator is preferably a heat and/or light decomposable initiator. The binder polymer is preferably a fluorine-containing polymer having a crosslinkable or polymerizable functional group, while the curable compound is preferably a non-fluorine compound.

### [Binder Polymer]

The binder polymer is preferably a fluorine-containing polymer.

### {Fluorine-Containing Polymer}

The fluorine-containing polymer is preferably a polymer capable of giving a cured film a dynamic friction coefficient of from 0.03 to 0.20, a contact angle with water of from 90 to 120° C. and a pure water sliding angle of 70° C. or less, and crosslinking by exposure to heat or ionizing radiation, from the viewpoint of improvement in productivity, for example, when application or curing is performed while web-transporting a roll film.

When the antireflection film of the invention is installed on an image display device, as the peel force with a commercially available adhesive tape is lower, it peels off more easily after a seal or a memo is attached. The peel force is therefore preferably 500 gf or less, more preferably 300 gf or less, most preferably 100 gf or less. Furthermore, the antireflection film is more scratch resistant as the surface hardness measured by a microhardness tester is higher so that the surface hardness is preferably 0.3 GPa or greater, more preferably 0.5 GPa or greater.

The fluorine-containing polymer used for the low refractive index layer is preferably a fluorine-containing compound containing a crosslinkable or polymerizable functional group. Examples include, in addition to hydrolysates or dehydration condensates of perfluoroalkyl-containing silane compounds (such as (heptadecafluoro-1,1,2,2-tetradecyl)triethoxysilane), fluorine-containing copolymers of a fluorine-containing monomer and a monomer for imparting a crosslinkable group. The fluorine-containing copolymer preferably has a main chain composed only of carbon atoms. In other words, it preferably has neither oxygen atom nor nitrogen atom in its main chain skeleton.

The fluorine-containing polymer has a fluorine atom content of preferably from 35 to 80 mass %.

Specific examples of the fluorine-containing monomer include fluoroolefins (for example, fluoroethylene, vinylidene fluoride, tetrafluoroethylene, hexafluoroethylene, hexafluoropropylene, and perfluoro-2,2-dimethyl-1,3-dioxole), partially or completely fluorinated alkyl ester derivatives of (meth)acrylic acid (for example, “Viscoat 6FM” (trade name; product of Osaka Organic Chemical Industry) and “M-2020” (trade name; product of Daikin Industries)), and completely or partially fluorinated vinyl ethers. Perfluoroolefins are preferred, with hexafluoropropylene being especially preferred from the viewpoints of refractive index, solubility, transparency, availability, and the like. A refractive index can be decreased by an increase in the composition ratio of such a fluorine-containing vinyl monomer, but if so, strength of the film lowers. In the invention, the incorporation amount of the fluorine-containing vinyl monomer is controlled so as to give the fluorine content, in the copolymer, of from 20 to 60 mass %, more preferably from 25 to 55 mass %, especially preferably from 30 to 50 mass %.

The following units (a), (b), and (c) are mainly the constituent units for imparting a crosslinkable group.

(a): a constituent unit obtained by polymerization of a monomer originally having in the molecule thereof a self-crosslinkable functional group, such as glycidyl (meth)acrylate or glycidyl vinyl ether;

(b): a constituent unit obtained by polymerization of a monomer having a carboxyl group, hydroxyl group, amino group, sulfo group or the like (for example, (meth)acrylic acid, methylol (meth)acrylate, hydroxyalkyl(meth)acrylate, allyl acrylate, hydroxyethyl vinyl ether, hydroxybutyl vinyl ether, maleic acid, or crotonic acid). It is described in JP-A-10-25388 and JP-A-10-147739 that a crosslinked structure can be introduced in this case after copolymerization.

(c): a constituent unit available by reacting a compound having, in the molecule thereof, a group reactive with the functional group of the above-described (a) or (b) and another crosslinkable functional group with the above-described constituent unit of (a) or (b) (for example, a constituent unit which can be synthesized by a method such as a method of acting acrylic chloride on a hydroxyl group).

In the constituent unit (c), a photopolymerizable group is especially preferred as the crosslinkable functional group in the invention. Examples of the photopolymerizable group include (meth)acryloyl group, alkenyl group, cinnamoyl group, cinnamylideneacetyl group, benzalacetophenone group, styrylpyridine group, α-phenylmaleimide group, phenylazide group, sulfonylazide group, carbonylazide group, diazo group, o-quinonediazide group, furylacryloyl group, coumarin group, pyrone group, anthracene group, benzophenone group, stilbene group, dithiocarbamate group, xanthate group, 1,2,3-thiadiazole group, cyclopropene group and azadioxabicyclo group. These groups may be used either singly or in combination. Of these groups, (meth)acryloyl group and cinnamoyl group are preferred, with (meth)acryloyl group being especially preferred.

The copolymer containing a photopolymerizable group can be prepared by any one of the following processes, but the process is not limited thereto.

(1) A process of reacting (meth)acrylic chloride with a crosslinkable-functional-group-containing copolymer containing a hydroxyl group to form the corresponding ester.

(2) A process of reacting an isocyanate-containing (meth)acrylate ester with a crosslinkable-functional-group-containing copolymer containing a hydroxyl group to form the corresponding urethane.

(3) A process of reacting (meth)acrylic acid with a crosslinkable-functional-group-containing copolymer containing an epoxy group to form the corresponding ester.

(4) A process of reacting an epoxy-containing (meth)acrylate ester with a crosslinkable-functional-group-containing copolymer containing a carboxyl group to form the corresponding ester.

An incorporation amount of the photopolymerizable group can be regulated arbitrarily, and it is also preferred to leave a predetermined amount of a carboxyl group or a hydroxyl group in consideration of the surface stability of the coating, reduction of the surface defects in the presence of inorganic fine particles and improvement in the film strength.

Not only the above-described copolymer of the fluorine-containing monomer and the monomer for imparting a crosslinkable group but also a copolymer obtained by other monomers may be used. A plurality of such monomers may be used in combination, depending on the using purpose. They are incorporated preferably in a total amount ranging from 0 to 65 mole %, more preferably from 0 to 40 mole %, especially preferably from 0 to 30 mole % in the copolymer.

No particular limitation is imposed on the monomer usable in combination and examples of it include olefins (such as ethylene, propylene, isoprene, vinyl chloride and vinylidene chloride), acrylate esters (such as methyl acrylate, ethyl acrylate and 2-ethylhexyl acrylate), methacrylate esters (such as methyl methacrylate, ethyl methacrylate, butyl methacrylate and ethylene glycol dimethacrylate), styrene derivatives (such as styrene, divinyl benzene, vinyl toluene and α-methylstyrene), vinyl ethers (such as methyl vinyl ether, ethyl vinyl ether, cyclohexyl vinyl ether, hydroxyethyl vinyl ether, and hydroxybutyl vinyl ether), vinyl esters (such as vinyl acetate, vinyl propionate, and vinyl cinnamate), unsaturated carboxylic acids (such as acrylic acid, methacrylic acid, crotonic acid, maleic acid and itaconic acid), acrylamides (such as N-t-butyl acrylamide and N-cyclohexylacrylamide), methacrylamides, and acrylonitrile derivatives.

As the binder preferably usable for the low refractive index layer of the antireflection film of the invention, copolymers as described in from [0030] to [0047] of JP-A-2004-45462 can be mentioned.

The fluorine-containing polymer particularly useful in the invention is a random copolymer of a perfluoroolefin and a vinyl ether or a vinyl ester. In particular, it preferably has a group capable of undergoing a crosslinking reaction singly (for example, a radical reactive group such as a (meth)acryloyl group or a ring-opening polymerizable group such as epoxy group or oxetanyl group). Such a crosslinkable-group-containing polymerization unit preferably amounts to from 5 to 70 mole %, especially preferably from 30 to 60 mole %, of all the polymerization units of the polymer.

Examples of the preferred polymers include those described in JP-A-2002-243907, JP-A-2002-372601, JP-A-2003-26732, JP-A-2003-222702, JP-A-2003-294911, JP-A-2003-329804, JP-A-2004-4444, and JP-A-2004-45462.

Also in the fluorine-containing polymer of the invention, a polysiloxane structure is preferably introduced for providing a film with an antifouling property. Although there is no particular limitation imposed on the introduction method of the polysiloxane structure, examples of the preferred method include a method of introducing a polysiloxane block copolymerization component utilizing a silicone macroazo initiator as described in JP-A-6-93100, JP-A-11-189621, JP-A-11-228631 and JP-A-2000-313709; and a method of introducing a polysiloxane graft copolymerization component utilizing a silicone macromer as described in JP-A-2-251555 and JP-A-2-308806. Examples of the especially preferred compound include polymers described in Examples 1, 2 and 3 of JP-A JP-A-11-189621, and copolymers A-2 and A-3 described in JP-A-2-251555. Such a polysiloxane component is preferably contained in an amount of from 0.5 to 10 mass %, especially preferably from 1 to 5 mass % in the polymer.

The polymer preferably usable in the invention has a mass average molecular weight of 5000 or greater, preferably from 10000 to 500000, most preferably from 15000 to 200000. The film surface or mar resistance can be improved by using polymers different in average molecular weight in combination.

### (Preferable Fluorine-Containing Polymer)

Fluorine-containing polymers represented by the below-described formula 6 or 7 are preferred as the fluorine-containing polymer usable in the invention.

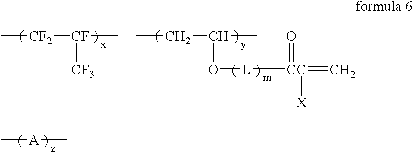

In the formula 6, L represents a C₁₋₁₀ linking group, more preferably a C₁₋₆ linking group, especially preferably a C₂₋₄ linking group. It may have a linear, branched, or cyclic structure, or may have a heteroatom selected from O, N, and S.

Preferred examples of L include *—(CH₂)₂—O—**, *—(CH₂)₂—NH—**, *—(CH₂)₄—O—**, *—(CH₂)₆—O—**, *—(CH₂)₂O—(CH₂)₂O—**, *—CONH—(CH₂)₃—O—**, *—CH₂CH(OH)CH₂—O—**, and *—CH₂CH₂OCONH(CH₂)₃—O—** (wherein, * represents a link site on the polymer main chain side, and ** represents a link site on the (meth)acryloyl group side). “m” stands for 0 or 1.

In the formula 6, X represents a hydrogen atom or a methyl group. From the viewpoint of curing reactivity, a hydrogen atom is more preferred.

In the formula 6, A represents a recurring unit derived from any vinyl monomer. No particular limitation is imposed on it insofar as it is a constituent component of a monomer copolymerizable with hexafluoropropylene, and can be selected as needed in view of various factors such as adhesion to the substrate, Tg of the polymer (which contributes to film hardness), solubility in a solvent, transparency, lubrication and anti-dust/anti-fouling property. The recurring unit may be composed of either a single monomer or a plurality of vinyl monomers, depending on the using purpose.

Preferred examples include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl (meth)acrylate, ethyl(meth)acrylate, hydroxyethyl(meth)acrylate, glycidyl methacrylate, allyl(meth)acrylate, and (meth)acryloyloxypropyltrimethoxysilane; styrene and styrene derivatives such as p-hydroxymethylstyrene; and unsaturated carboxylic acids such as crotonic acid, maleic acid and itaconic acid, and derivatives thereof. Of these, vinyl ether derivatives and vinyl esters derivatives are more preferred, with vinyl ether derivatives being especially preferred.

“x”, “y”, and “z” represent mole % of respective components and they satisfy the following equations: 30≦x≦60, 5≦y≦70, and 0≦z≦65, preferably 35≦x≦55, 30≦y≦60, and 0≦z≦20, especially preferably 40≦x≦55, 40≦y≦55, and 0≦z≦0, respectively.

A more preferred copolymer to be used in the invention is represented by the following formula 7.

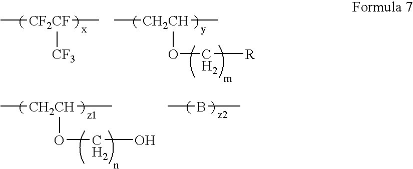

In the formula 7, R represents a C₁₋₁₀ alkyl group or it may be an ethylenically unsaturated group (—C(═O)C(—X)═CH₂) similar to that of the formula 6.

“m” stands for an integer satisfying the following equation 1≦n≦10, preferably 1≦n≦6, especially preferably 1≦n≦4.

“n” stands for an integer satisfying 2≦n≦10, preferably 2≦n≦6, especially preferably 2≦n≦4.

B represents a recurring unit derived from any vinyl monomers, which may be composed of either a single composition or a plurality of compositions. B may contain a silicone moiety.

“x”, “y”, “z1”, and “z2” represent mole % of the respective recurring units. “x” and “y” preferably satisfy 30≦x≦60 and 0≦y≦70, more preferably 35≦x≦55 and 0≦y≦60, especially preferably 40≦x≦55 and 0≦y≦55, respectively. “z1” and “z2” preferably satisfy 1≦z1≦65 and 1≦z2≦65, more preferably 1≦z1≦40 and 1≦z2≦10, especially preferably 1≦z1≦30 and 1≦z2≦5, respectively. Note that x+y+z1+z2=100.

The fluorine-containing polymer of the invention preferably has a constituent unit having the below-described polysiloxane structure in order to impart an antifouling property to the resulting film. Examples of the fluorine-containing polymer having a polysiloxane structure useful in the invention include fluorine-containing polymers having a main chain composed only of carbon atoms and containing at least one of (a) a fluorine-containing vinyl monomer polymerization unit, (b) a hydroxyl-containing vinyl monomer polymerization unit and (c) a polymerization unit having, in the side chain thereof, a graft moiety containing a polysiloxane recurring unit represented by the below-described formula 1.

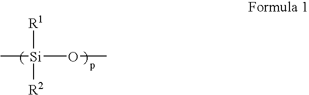

In the formula 1, R¹ and R² may be the same or different and each represents an alkyl group or an aryl group. The alkyl group is preferably a C₁₋₄ alkyl group such as methyl, trifluoromethyl and ethyl. The aryl group is preferably a C₆₋₂₀ aryl group such as phenyl and naphthyl. Of these, methyl and phenyl groups are more preferred, with methyl group being especially preferred. “p” stands for an integer of from 2 to 500, preferably from 5 to 350, especially preferably from 8 to 250.

The polymer having, in the side chain thereof, a polysiloxane structure represented by formula 1 can be synthesized by a process of introducing, into a polymer having a reactive group such as epoxy group, hydroxyl group, carboxyl group or acid anhydride group, a polysiloxane (for example, “Silaplane” Series (trade name; product of Chisso) having, at one end thereof, the corresponding reactive group (for example, an amino group, mercapto group, carboxyl group or hydroxyl group for the epoxy group or acid anhydride group) by a polymer reaction as described, for example, in J. A. Appl. Polym. Sci., 2000, 78(1955) and JP-A-56-28219; or a process of polymerizing a polysiloxane-containing silicon macromer. Either process may be preferably used. In the invention, a process of introducing the structure by the polymerization of a silicon macromer is more preferred.

As the silicon macromer, any one having a polymerizable group permitting copolymerization with a fluorine-containing olefin can be used and a structure represented by any one of the following formulas 2 to 5 is preferred.

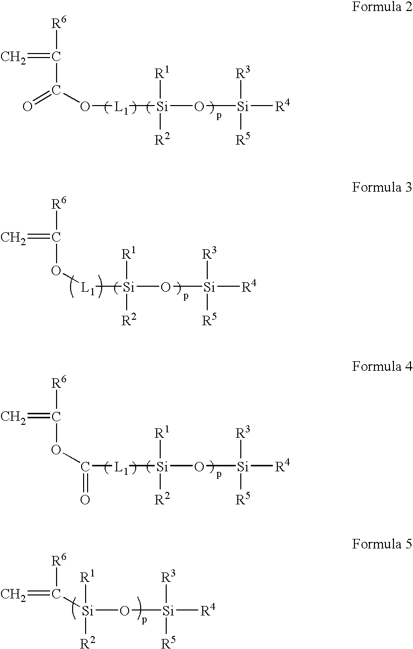

In the formulas 2 to 5, R¹, R² and p have the same meanings as described above in the formula 1, and preferred ranges are also similar to those described in the formula 1. R³ to R⁵ each independently represents a substituted or unsubstituted, monovalent organic group or a hydrogen atom, As R³ to R⁵, preferred are C₁₋₁₀ alkyl groups (such as methyl, ethyl, and octyl), C₁₋₁₀ alkoxy groups (such as methoxy, ethoxy and propyloxy), and C₆₋₂₀ aryl groups (such as phenyl and naphthyl), with C₁₋₅ alkyl groups being especially preferred. R⁶ represents a hydrogen atom or a methyl group. L₁ represents any linking group having from 1 to 20 carbon atoms and examples of it include substituted or unsubstituted linear, branched or alicyclic alkylene groups and substituted or unsubstituted arylene groups, preferably unsubstituted, linear C₁₋₂₀ alkyl alkylene groups, especially preferably an ethylene or propylene group. These compounds can be synthesized in accordance with the process as described in, for example, JP-A-6-322053.

Any of the compounds represented by the formulas 2 to 5 can be used preferably. Those having a structure represented by the formula 2, 3 or 4 are especially preferred from the standpoint of the copolymerizability with a fluorine-containing olefin. The amount of the above-described polysiloxane moiety is preferably from 0.01 to 20 mass %, more preferably from 0.05 to 15 mass %, especially preferably from 0.5 to 10% in the graft copolymer.

The preferred examples of the polymerization unit having, in the side chain thereof, a graft moiety containing a polysiloxane unit and useful in the invention will next be shown but the invention is not limited thereto.

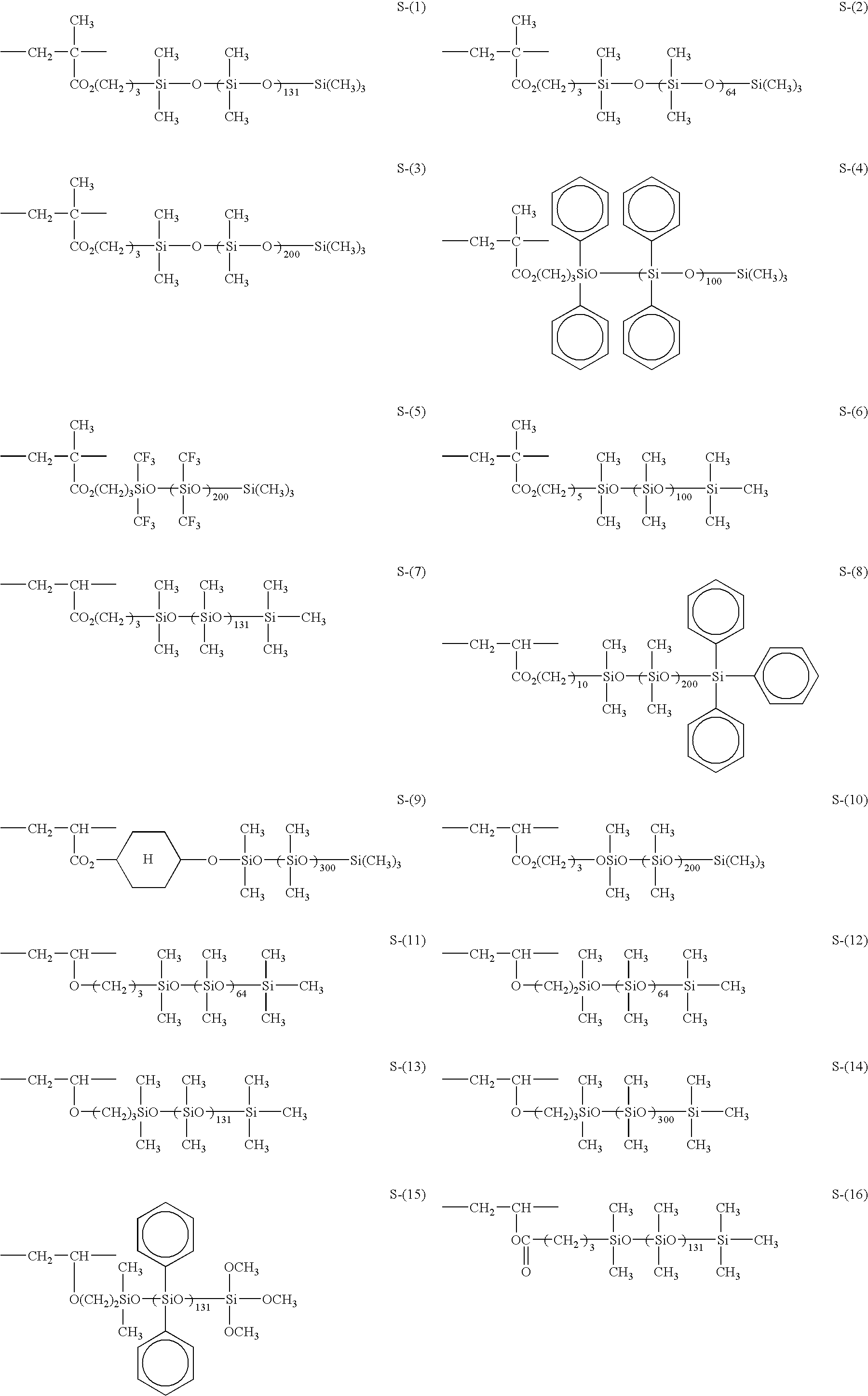

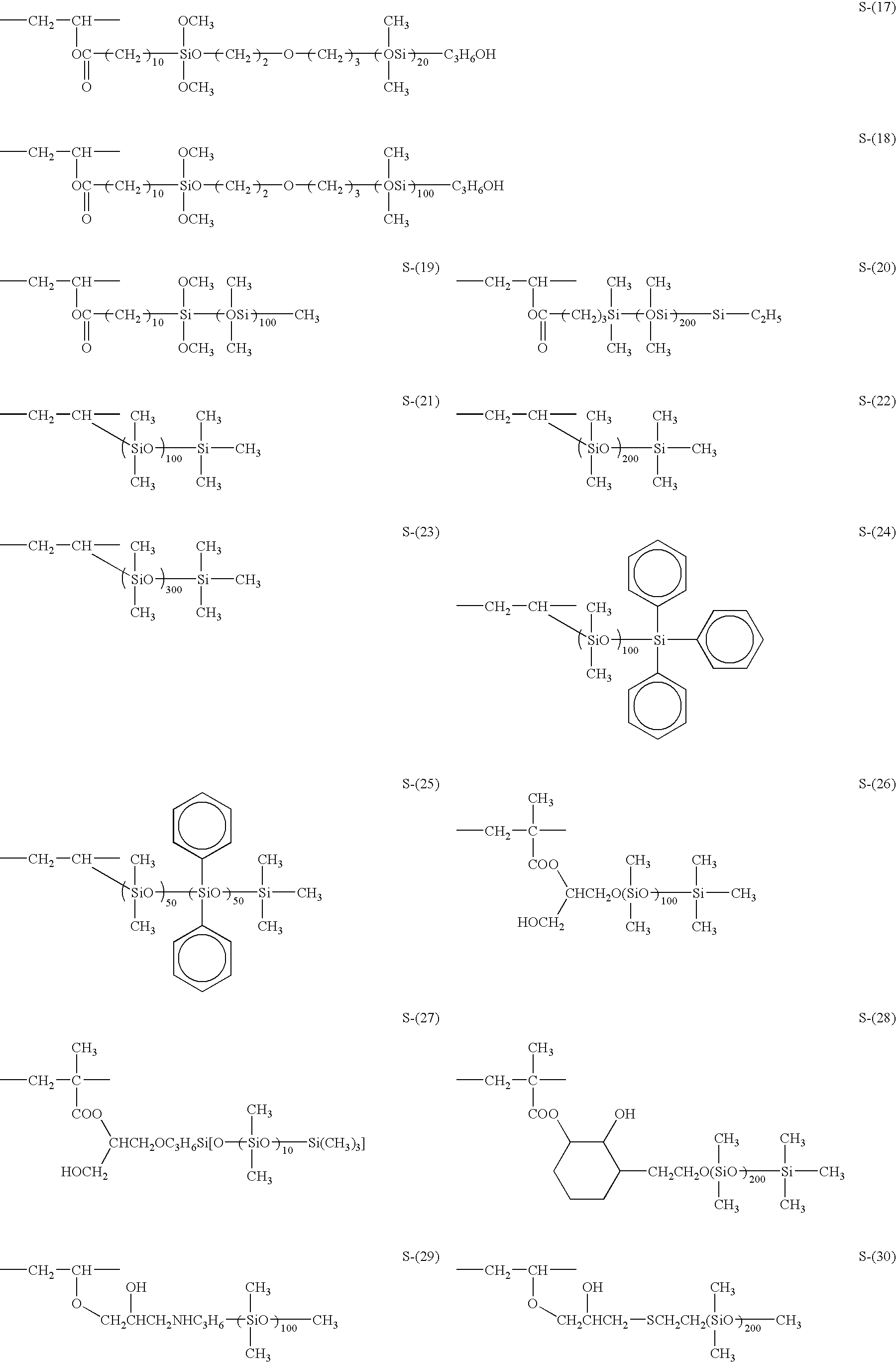

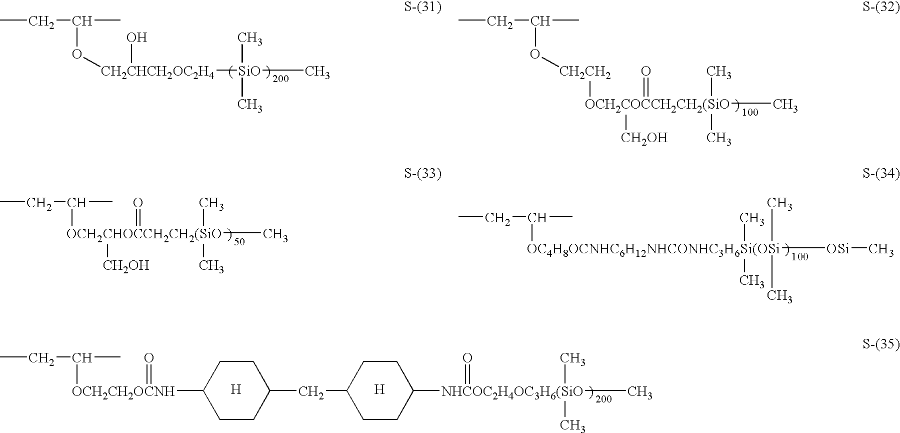

S-(36): “Silaplane FMO711” (trade name; product of Chisso)

S-(37): “Silaplane FM0721” (trade name; product of Chisso)

S-(38): “Silaplane FM0725” (trade name; product of Chisso)

By the introduction of the polysiloxane structure, the film is provided with antifouling property and dust resistance and in addition, lubrication is given to its surface. Such properties are also advantageous for improving the mar resistance.

### (Curing Agent)

It is possible to improve the curing property by incorporating a crosslinkable compound as a curing agent in the fluorine-containing polymer. When the polymer itself contains a hydroxyl group, any compound can be added as a curing agent insofar as it has, in one molecule thereof, two or more functional groups reactive with the hydroxyl group. Examples include polyisocyanates, partial condensates of an isocyanate compound, multimers, polyols, adducts with a low-molecular-weight polyester film, blocked polyisocyanate compounds obtained by blocking an isocyanate group with a blocking agent such as phenol, aminoplasts, and polybasic acids and anhydrides thereof. When such a curing agent is used, the content of the hydroxyl-containing monomer unit is preferably 1% or greater but not greater than 65%, more preferably 1% or greater but not greater than 50%.

Among the curing agents reactive with a hydroxyl group, aminoplasts which undergo a crosslinking reaction with a hydroxyl-containing compound under acid conditions are preferred from the viewpoints of satisfying both the storage stability and activity of the crosslinking reaction, and strength of the film thus formed. Aminoplasts are compounds which contain an amino group, such as hydroxyalkylamino group or alkoxyalkylamino group, reactive with the hydroxyl group present in the fluorine-containing polymer or which contain a carbon atom adjacent to a nitrogen atom and substituted with an alkoxy group. Specific examples include melamine compounds, urea compounds, and benzoguanamine compounds.

The above-described melamine compound is generally known to have a skeleton in which a nitrogen atom is bound to a triazine ring and specific examples include melamine, alkylated melamine, methylolmelamine and alkoxylated methylmelamine. Of these, methylolated melamine obtained by reacting melamine and formaldehyde under basic conditions, and alkoxylated melamine or derivatives thereof are preferred, with alkoxylated melamine being especially preferred from the viewpoint of storage stability. No particular limitation is imposed on the methylolated melamine or alkoxylated methylmelamine and various resins available by the process as described in Plastic Zairyo Koza [8] Uurea•melamine resins (published by Nikkan Kogyo Shimbun) can also be used.

As the urea compound, in addition to urea, polymethylolated urea and alkoxylated methylurea which is a derivative thereof are preferred. Moreover, compounds having a glycoluryl skeleton or 2-imidazolidinone skeleton which is a cyclic urea structure are also preferred. As the amino compounds such as urea derivatives, various resins as described in the above-described “Urea•melamine resins” can also be employed.

As compounds preferably used as a crosslinking agent in the invention, melamine compounds and glycoluryl compounds are especially preferred from the standpoint of compatibility with the fluorine-containing copolymer. Of theses, compounds having, in the molecule thereof, nitrogen atoms and at the same time, having two or more carbon atoms substituted with the alkoxy groups adjacent to the nitrogen atoms are preferred as the crosslinking agent from the viewpoint of the reactivity. Compounds having a structure represented by the below-described H-1 or H-2, and partial condensates thereof are especially preferred. In the below-described formulas, Rs each represents a C₁₋₆ alkyl or hydroxyl group.

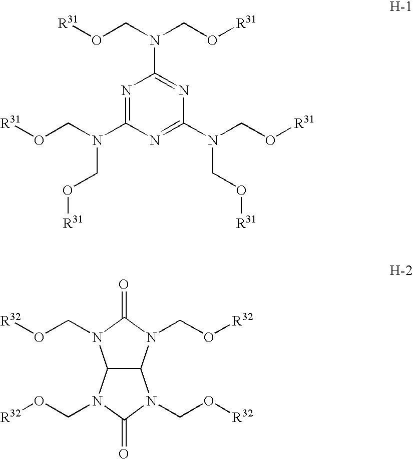

The aminoplast is added to the fluorine-containing polymer in an amount of from 1 to 50 parts by mass, preferably from 3 to 40 parts by mass, more preferably from 5 to 30 parts by mass per 100 parts by mass of the copolymer. When the amount is 1 part by mass or greater, durability as a thin film, which is a characteristic of the invention can be demonstrated sufficiently. Amounts not greater than 50 parts by mass are preferred because a low refractive index, which is a characteristic of the low refractive index layer of the invention, can be maintained when the film is used for an optical purpose. A curing agent not causing an increase the refractive index even by its addition is preferred from the viewpoint of maintaining the refractive index at a lower level even if the agent is added. From this viewpoint, compounds having a skeleton represented by H-2 are more preferred.

### (Curing Catalyst)

In the antireflection film of the invention, when curing is conducted by the crosslinking reaction between the hydroxyl group of the fluorine-containing polymer and the curing agent while heating, it is preferred to add an acidic substance to the curable resin composition because curing is accelerated by an acid in such a system. When a common acid is added thereto, however, a crosslinking reaction proceeds in the coating solution and it becomes a cause of troubles (such as unevenness and repelling). It is therefore more preferred to add, as a curing catalyst, a compound which generates an acid by heating in order to accomplish both the storage stability and curing activity in the heat curing system.

The curing catalyst is preferably a salt composed of an acid and an organic base. Examples of the acid include organic acids such as sulfonic acid, phosphonic acid and carboxylic acid and inorganic acids such as sulfuric acid and phosphoric acid. From the standpoint of compatibility with the polymer, organic acids are more preferred, sulfonic acid and phosphonic acid are still more preferred and sulfonic acid is most preferred. Preferred examples of the sulfonic acid include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH) and nonafluorobutane-1-sulfonic acid (NFBS). Any of them may be used preferably (abbreviations are shown in parentheses).

The curing catalyst varies greatly depending on basicity or boiling point of the organic base to be used in combination with the acid. The curing catalysts preferably used in the invention will next be described from respective viewpoints.

The organic bases having a lower basicity can efficiently generate acid at the time of heating and they are preferred in view of the curing activity but, when their basicity is too low, they cannot have sufficient storage stability. Use of organic bases having an appropriate basicity is therefore preferred. When pKa of a conjugated acid is used as an index of basicity, the pKa of the organic base used in the invention must be from 5.0 to 10.5, more preferably from 6.0 to 10.0, still more preferably from 6.5 to 10.0. The pKa values of organic bases are described in “Kagaku Benran—Kisohen”, Vol. 2-II, 334-340(2004) (Handbook of Chemistry—Fundamental Section) (revised fifth edition, edited by the Chemical Society of Japan, published by Maruzen so that organic bases having an adequate pKA can be selected from them. Even compounds which are not mentioned in that book but are estimated to have an adequate pKa value may also be used preferably. In Table 1, compounds described in the book and having an adequate pKa value are shown. It is however noted that the compounds preferably used in the invention are not limited to them.

TABLE 1
Organic base

| No. | Chemical name | pKa |
|---|---|---|
| b-1 | N,N-Dimethylaniline | 5.1 |
| b-2 | Benzimidazole | 5.5 |
| b-3 | Pyridine | 5.7 |
| b-4 | 3-Methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-Dimethylamino)pyridine | 6.5 |
| b-10 | 2,6-Dimethylpyridine | 7.0 |
| b-11 | Imidazole | 7.0 |
| b-12 | 2-Methylimidazole | 7.6 |
| b-13 | N-Ethylmorpholine | 7.7 |
| b-14 | N-Methylmorpholine | 7.8 |
| b-15 | Bis(2-methoxyethyl)amine | 8.9 |
| b-16 | 2,2′-Iminodiethanol | 9.1 |
| b-17 | N,N-Dimethyl-2-aminoethanol | 9.5 |
| b-18 | Trimethylamine | 9.9 |
| b-19 | Triethylamine | 10.7 |

The organic base having a lower boiling point is preferred from the viewpoint of curing activity because its acid generation efficiency is high upon heating. Use of an organic base having an adequate boiling point is therefore preferred. The boiling point of the base is preferably 120° C. or less, more preferably 80° C. or less, still more preferably 70° C. or less.

The following compounds can be given, for example, as the organic base preferably used in the invention, but the organic base is not limited thereto. A boiling point is shown in parentheses.

b-3: pyridine (115° C.), b-14: 4-methylmorpholine (115° C.), b-20: diallylmethylamine (111° C.), b-19: triethylamine (88.8° C.), b-21: t-butylmethylamine (from 67 to 69° C.), b-22: dimethylisopropylamine (66° C.), b-23: diethylmethylamine (from 63 to 65° C.), b-24: dimethylethylamine (from 36 to 38° C.), b-18: trimethylamine (from 3 to 5° C.)

The boiling point of the organic base usable preferably in the invention is 35° C. or greater but not greater than 85° C. At temperatures exceeding this range, deterioration in scratch resistance occurs while at temperatures below 35° C., the coating solution becomes unstable. The boiling point is more preferably 45° C. or greater but not greater than 80° C., most preferably 55° C. or greater but not greater than 75° C.

When the organic base is used as the acid catalyst of the invention, a salt made of the acid and organic base may be used after isolation or the acid and organic base are mixed to form the corresponding salt in a solution and the resulting solution may be used. For each of the acid and organic base, only one kind thereof may be used or plural kinds thereof may be used as a mixture. When the acid and organic base are used as a mixture, the acid and the organic base are mixed to give an acid/organic base equivalent ratio will fall within a range of 1:0.9 to 1.5, more preferably 1:0.95 to 1.3, most preferably 1:1.0 to 1.1.

The acid catalyst is used preferably in an amount of from 0.01 to 10 parts by mass, more preferably from 0.1 to 5 parts by mass, still more preferably from 0.2 to 3 parts by mass based on 100 parts by mass of the fluorine-containing polymer in the curable resin composition.

In the invention, a compound which generates an acid when exposed to light, that is, a photosensitive acid generator may be added further in addition to the above-described thermal acid generator. As the photosensitive acid generator, known compounds such as photoinitiators for photo-initiated cationic polymerization, photo decolorizers of dyes, photo discolorizers and known acid generators used for microresist or the like, and mixtures thereof are usable. The photosensitive acid generator is a substance capable of providing the coating of the curable resin composition with photosensitivity and enabling photocuring of the film, for example, by exposure to radiation such as light.

Examples of the photosensitive acid generator include (1) various onium salts such as iodonium salt, sulfonium salt, phosphonium salt, diazonium salt, ammonium salt, imminium salt, pyridinium salt, arsonium salt and selenonium salt (preferably, diazonium salt, iodonium salt, sulfonium salt and iminium salt); (2) sulfone compounds such as β-ketoester and β-sulfonylsulfone and α-diazo compounds thereof; (3) sulfonate esters such as alkyl sulfonate, haloalkyl sulfonate, aryl sulfonate and iminosulfonate; (4) sulfonimide compounds; (5) diazomethane compounds; (6) trihalomethyltriazines; and others. They may be used as needed. The onium salts (1) include, for example, compounds as described in from [0058] to [0059] in JP-A-2002-29162.

Specific compounds or using methods described, for example, in JP-A-2005-43876 can be used similarly as those of the above-described photosensitive acid generators.

These photosensitive acid generators may be used either singly or in combination. They can also be used in combination with the above-described thermal acid generator. The photosensitive acid generator is used in an amount of preferably from 0 to 20 parts by mass, more preferably from 0.1 to 10 parts by mass based on 100 parts by mass of the fluorine-containing polymer in the composition for forming a low refractive index layer. Amounts of the photosensitive acid generator not greater than the upper limit are preferred because if so, the resulting cured film has excellent strength and good transparency.

A description will next be made of the curable compound (b) having an ethylenically unsaturated group.

As the curable compound (b), monomers having two or more ethylenically unsaturated groups can be used. As the monomers, proper ones selected from the various monomers described in the (Binder polymer having, as a main chain thereof, a saturated hydrocarbon chain)/[Binder polymer]/[Hard coat layer] are usable. These monomers can raise the density of the crosslinking group in the binder and therefore contribute to the formation of a cured film having a high hardness, but their refractive index is not lower than that of the fluorine-containing polymer binder. It can however have a sufficiently effective refractive index as a low refractive index layer of the antireflection film of the invention by using, in combination, a hydrolysate of an organosilane and/or partial condensate thereof, or inorganic fine particles having a hollow structure.

### (Hydrolysate of an Organosilane Compound and/or Partial Condensate Thereof)

The curable compound is preferably a non-fluorine compound in order to make the surface free energy higher than that of the fluorine compound, thereby localizing it below the fluorine-containing binder. Among non-fluorine compounds, hydrolysates of an organosilane compound and/or partial condensates thereof which have an ethylenically unsaturated group and have a hydroxyl group or hydrolyzable group directly bound to silicon, so-called sol components are especially preferred.

The organosilane compound is preferably represented by the following formula (b):

(R³¹)ₘ₃—SiX³¹₄₋ₘ₃ Formula (b):

In the formula (b), R³¹ represents a substituted or unsubstituted alkyl group or a substituted or unsubstituted aryl group. Examples of the alkyl group include methyl, ethyl, propyl, isopropyl, hexyl, decyl, and hexadecyl. As the alkyl group, C₁₋₃₀, more preferably C₁₋₁₆, especially preferably C₁₋₆ alkyl groups are preferred. Examples of the aryl group include phenyl and naphthyl, with phenyl being preferred.

X³¹ represents a hydroxyl group or a hydrolyzable group, such as an alkoxy group (preferably a C₁₋₅ alkoxy group such as methoxy or ethoxy), a halogen atom (such as Cl, Br or I) or a group represented by R³²COO(R³² is preferably a hydrogen atom or a C₁₋₅ alkyl group and R³²COO is preferably CH₃COO, C₂H₅COO, or the like), preferably an alkoxy group, especially preferably a methoxy or ethoxy group.

“m” stands for an integer of from 1 to 3, preferably 1 or 2.

When there are a plurality of R³¹s or X³¹s, the plurality of R³¹s or X³¹s may be the same or different.

No particular limitation is imposed on the substituent contained in R³¹. Examples of it include halogen atoms (such as fluorine, chlorine and bromine), hydroxyl group, mercapto group, carboxyl group, epoxy group, alkyl groups (such as methyl, ethyl, i-propyl, propyl and t-butyl), aryl groups (such as phenyl and naphthyl), aromatic heterocyclic groups (such as furyl, pyrazolyl and pyridyl), alkoxy groups (such as methoxy, ethoxy, i-propoxy, and hexyloxy), aryloxy groups (such as phenoxy), alkylthio groups (such as methylthio and ethylthio), arylthio groups (such as phenylthio), alkenyl groups (such as vinyl and 1-propenyl), acyloxy groups (such as acetoxy, acryloyloxy and methacryloyloxy), alkoxycarbonyl groups (such as methoxycarbonyl and ethoxycarbonyl), aryloxycarbonyl groups (such as phenoxycarbonyl), carbamoyl groups (such as carbamoyl, N-methylcarbamoyl, N,N-dimethylcarbamoyl and N-methyl-N-octylcarbamoyl), and acylamino groups (such as acetylamino, benzoylamino, acryloylamino and methacryloylamino). These substituents may be substituted further.

When a plurality of R³¹s are present, at least one of them is preferably a substituted alkyl group or a substituted aryl group.

By using one or more of the above-described organosilane compounds, a hydrolysate and/or partial condensate thereof may be prepared.

The hydrolysate of the organosilane compound and/or partial condensate thereof which is used preferably as the curable compound (b) contains an ethylenically unsaturated group and can be prepared by using, as at least one of the organosilane compounds used for the preparation of the sol component, the compound of the formula (b) having an ethylenically unsaturated group as R³¹.

In order to obtain the effect of the invention, the hydrolysate of the organosilane compound and/or partial condensate thereof contains preferably from 30 to 100 mass %, more preferably from 50 to 100 mass %, still more preferably from 70 to 95 mass % of the organosilane compound having an ethylenically unsaturated group. When the content of the organosilane compound having an ethylenically unsaturated group is 30 mass % or greater, there does not occur any trouble such as appearance of an insoluble portion, turbidity of the solution, worsening of a pot life, difficulty in the control of the molecular weight (increase in the molecular weight) and difficulty in achieving improvement of properties (for example, mar resistance of the antireflection film) upon polymerization treatment owing to a small content of the polymerizable group.

At least either one of the hydrolysate of the organosilane compound and/or partial condensate thereof to be used in the invention has preferably a suppressed volatility for stabilizing the properties of the applied product. More specifically, it has a volatility, per hour at 105° C., of preferably 5 mass % or less, more preferably 3 mass % of less, especially preferably 1 mass % or less.

### (Preparation Process of Organosilane Sol)

The preparation process of the organosilane sol will next be described.

The hydrolysis of an organosilane compound and/or condensation reaction thereof is performed by adding from 0.3 to 2.0 moles, preferably from 0.5 to 1.0 mole of water to one mole of a hydrolyzable group and then stirring the resulting mixture at from 25 to 100° C. in the presence of a metal chelate compound.

The mass average molecular weight of the resulting organosilane sol is, when components having a molecular weight less than 300 are eliminated, preferably from 450 to 20000, more preferably from 500 to 10000, still more preferably from 550 to 5000, especially preferably from 600 to 3000, most preferably from 1000 to 2000. Of the components of the organosilane sol having a molecular weight of 300 or greater, components having a molecular weight of 20000 or greater amount to preferably 20 mass % or less, more preferably 15 mass % or less, still more preferably 10 mass % or less, still more preferably 6 mass % or less, especially preferably 5 mass % or less. When the amount of the components having a molecular weight of 20000 or greater is 20 mass % or less, a cured film available by curing a composition containing the hydrolysate of such an organosilane compound and/or partial condensate thereof has excellent transparency and adhesion with a substrate. Amounts within the above-described range are therefore preferred.

Of the components of the organosilane sol having a molecular weight of 300 or greater, the components having a molecular weight of from 450 to 20000 amount to preferably 80 mass % or greater. The organosilane sol containing the components with a molecular weight of from 450 to 20000 in an amount of the lower limit or greater is preferred because if so, the cured coating available by curing the composition containing such an organosilane sol has excellent transparency and adhesion with a substrate film.

The mass average molecular weight and molecular weight as referred to herein are each determined by the detection through a differential refractometer with a GPC analyzer using a column of “TSKgel GMHxL”, “TSKgel G4000HxL” or “TSKgel G2000HxL” (each, trade name, product of Tosoh) while using tetrahydrofuran (THF) as a solvent, and is expressed in terms of polystyrene. The content is area % of the peak within the molecular weight range assuming that the area of peaks of the components having a molecular weight of 300 or greater is 100%.

The distribution (mass average molecular weight/number average molecular weight) is preferably from 3.0 to 1.1, more preferably from 2.5 to 1.1, still more preferably from 2.0 to 1.1, especially preferably from 1.5 to 1.1.

The hydrolysis of an organosilane compound and/or condensation reaction thereof can be performed in a solvent or in a solventless manner. The curable compound can be prepared by this reaction.

### (Solvent)

When a solvent is employed, the concentration of the organosilane sol can be determined as needed. As the solvent, an organic solvent is preferably used for uniformly mixing the components and for example, alcohols, aromatic hydrocarbons, ethers, ketones and esters are suited. In addition, the solvents capable of dissolving therein the organosilane and catalyst are preferred. Use of the organic solvent as a coating solution or a part of the coating solution is preferred in view of the efficiency of the step. Solvents not impairing solubility or dispersibility are preferred when they are mixed with another material such as fluorine-containing polymer.

Of these solvents, alcohols are preferably monoalcohols or dialcohols. The monoalcohols are preferably saturated aliphatic alcohols having from 1 to 8 carbon atoms. Specific examples of these alcohols include methanol, ethanol, n-propyl alcohol, i-propyl alcohol, n-butyl alcohol, s-butyl alcohol, t-butyl alcohol, ethylene glycol, diethylene glycol and triethylene glycol.

Specific examples of the aromatic hydrocarbons include benzene, toluene, xylene; specific examples of the ethers include tetrahydrofuran, dioxane and ethylene glycol monobutyl ether; specific examples of the ketones include acetone, methyl ethyl ketone, methyl isobutyl ketone and diisobutyl ketone; specific examples of the esters include ethyl acetate, propyl acetate, butyl acetate, propylene carbonate and ethylene glycol monoethyl ether acetate.

These organic solvents may be used either singly or in combination. Although no particular limitation is imposed on the solid concentration relative to the solvent upon the above-described reaction, it usually ranges from 1 to 90 mass %, preferably from 20 to 70 mass %.

### (Catalyst)

The hydrolysis of an organosilane compound and/or condensation reaction thereof is performed preferably in the presence of a catalyst. Examples of the catalyst include inorganic acids such as hydrochloric acid, sulfuric acid and nitric acid; organic acids such as oxalic acid, acetic acid, formic acid, methanesulfonic acid and toluenesulfonic acid; inorganic bases such as sodium hydroxide, potassium hydroxide and ammonia; organic bases such as triethylamine and pyridine, and metal alkoxides such as triisopropoxyaluminum and tetrabutoxyzirconium. In the invention, acid catalysts (inorganic acids and organic acids) are used from the viewpoints of production stability and storage stability of a sol solution. Of the inorganic acids, hydrochloric acid and sulfuric acid are preferred, while of the organic acids, those having an acid dissociation constant {pKa value (at 25° C.)} in water of 4.5 or less are preferred, of which hydrochloric acid, sulfuric acid and organic acids having an acid dissociation constant in water of 3.0 or less are more preferred, organic acids having an acid dissociation constant in water of 2.5 or less are still more preferred, methanesulfonic acid, oxalic acid, phthalic acid and malonic acid are still more preferred, and oxalic acid is especially preferred.

The hydrolysis and/or condensation reaction is usually performed by adding from 0.3 to 2 moles, preferably from 0.5 to 1 mole of water to 1 mole of the hydrolyzable group of the organosilane compound and stirring the resulting mixture at from 25 to 100° C. in the presence or absence of the solvent and in the presence of the acid catalyst and metal chelate compound.

When the hydrolyzable group is an alkoxy group and the acid catalyst is an organic acid, the amount of water can be reduced because the carboxyl group or sulfo group of the organic acid supplies proton. The amount of water added to 1 mole of the hydrolyzable group such as alkoxy group of the organosilane compound is from 0 to 2 moles, preferably from 0 to 1.5 moles, more preferably from 0 to 1 mole, especially preferably from 0 to 0.5 mole. When the alcohol is used as the solvent, the reaction without substantial addition of water is preferred.

When the acid catalyst is an inorganic acid, it is used in an amount of from 0.01 to 10 mole %, preferably from 0.1 to 5 mole % relative to the hydrolyzable group. When the acid catalyst is an organic acid, on the other hand, the optimum amount of it differs, depending on the amount of water. When water is added, it is from 0.01 to 10 mole %, preferably from 0.1 to 5 mole % relative to the hydrolyzable group. When water is not added substantially, it is from 1 to 500 mole %, preferably from 10 to 200 mole %, still more preferably from 20 to 200 mole %, still more preferably from 50 to 150 mole %, especially preferably from 50 to 120 mole % relative to the hydrolyzable group.

### (Metal Chelate Compound)

A metal chelate compound can be used preferably without particular limitation insofar as it has, as a central metal, a metal selected from Zr, Ti, and Al, and also has, as ligands, an alcohol represented by the formula: R⁴¹OH (wherein, R⁴¹ represents a C₁₋₁₀ alkyl group) and a compound represented by the formula: R⁴²COCH₂COR⁴³ (wherein, R⁴² represents a C₁₋₁₀ alkyl group, and R⁴³ represents a C₁₋₁₀ alkyl group or a C₁₋₁₀ alkoxy group). Within the above-described category, two or more metal chelate compounds may be used in combination.

The metal chelate compound to be used in the invention is preferably selected from the group consisting of compounds represented by the formulas: Zr(OR⁴¹)ₚ₁(R⁴²COCHCOR⁴³)ₚ₂, Ti(OR⁴¹)_{q1}(R⁴²COCHCOR⁴³)_{q2}, and Al(OR⁴¹)ᵣ₁(R⁴²COCHCOR⁴³)ᵣ₂. It is effective for accelerating the condensation reaction of the organosilane compound.

R⁴¹ and R⁴² in the metal chelate compound may be the same or different, and each represents a C₁₋₁₀ alkyl group (more specifically, ethyl, n-propyl, i-propyl, n-butyl, s-butyl, t-butyl or n-pentyl), a phenyl group, or the like. R⁴³ represents, in addition to the above-described C₁₋₁₀ alkyl group, a C₁₋₁₀ alkoxy group such as methoxy, ethoxy, n-propoxy, i-propoxy, n-butoxy, s-butoxy or t-butoxy. In the metal chelate compound, p1, p2, q1, q2, r1, and r2 stand for integers determined so as to obtain quadridentate or hexadentate ligands.

Specific examples of these metal chelate compounds include zirconium chelate compounds such as tri-n-butoxyethylacetoacetate zirconium, di-n-butoxybis(ethylacetoacetate) zirconium, n-butoxytris(ethylacetoacetate) zirconium, tetrakis(n-propylacetoacetate) zirconium, tetrakis(acetylacetoacetate) zirconium, and tetrakis(ethylacetoacetate) zirconium; titanium chelate compounds such as diisopropoxy•bis(ethylacetoacetate) titanium, diisopropoxy•bis(acetylacetate) titanium, and diisopropoxy•bis(acetylacetonate) titanium; and aluminum chelate compounds such as diisopropoxyethylacetoacetate aluminum, diisopropoxyacetylacetonate aluminum, isopropoxybis(ethylacetoacetate) aluminum, isopropoxybis(acetylacetonate) aluminum, tris(ethylacetoacetate) aluminum, tris(acetylacetonate) aluminum and monoacetylacetonato•bis(ethylacetoacetate) aluminum.

Of these metal chelate compounds, tri-n-butoxyethylacetoacetate zirconium, diisopropoxy•bis(acetylacetonate) titanium, diisopropoxyethylacetoacetate aluminum, and tris(ethylacetoacetate) aluminum are preferred. These metal chelate compounds can be used either singly or in combination. Also, partial hydrolysates of these metal chelate compounds are usable as the metal chelate compound.

The metal chelate compound is added preferably in an amount of from 0.01 to 50 mass %, more preferably from 0.1 to 50 mass %, still more preferably from 0.5 to 10 mass % relative to the organosilane compound represented by the formula (b). When the amount of the metal chelate compound component is the lower limit or above, the condensation reaction of the organosilane compound proceeds smoothly and the coating thus obtained has excellent durability. When the amount is not greater than the upper limit, on the other hand, there does not arise any trouble such as deterioration in storage stability of the composition containing the organosilane compound and metal chelate compound components. Amounts within the above-described range are therefore preferred.

The hydrolysis of an organosilane compound and/or condensation reaction thereof is performed by stirring at from 25 to 100° C. but the temperature is preferably adjusted, depending on the reactivity of the organosilane compound employed.

The amount of the organosilane sol to the low refractive index layer is preferably from 0.1 to 50 mass %, more preferably from 0.5 to 20 mass %, especially preferably from 1 to 10 mass %, each of the total solid content of the low refractive index layer.

The organosilane sol can also be added to a layer other than the low refractive index layer and the amount in such a case is preferably from 0.001 to 50 mass %, more preferably from 0.01 to 20 mass %, more preferably from 0.05 to 10 mass %, especially preferably from 0.1 to 5 mass %, each of the total solid content of the layer to be added.

The amount (ratio) of the organosilane sol is preferably from 5 to 100 mass %, more preferably from 5 to 40 mass %, still more preferably from 8 to 35 mass %, especially preferably from 10 to 30 mass %, relative to the fluorine-containing polymer in the low refractive index layer. When the amount is the lower limit or greater, the advantage of the invention can be demonstrated fully and when the amount is not greater than the upper limit, troubles such as increase in the refractive index and worsening of the shape or surface condition of the film do not occur. Amounts within the above-described range are therefore preferred.

The polymerization initiator contained in the composition for forming a low refractive index layer is, as described above, preferably a heat and/or light decomposable initiator. Any polymerization initiator is usable without limitation insofar as it is ordinarily employed. The SP values of the polymerization initiator and curable compound having an ethylenically unsaturated group to be used in the invention are each preferably greater than that of the binder polymer to be used in combination. Localization of at least one polymerization initiator and curable compound (b) having an ethylenically unsaturated group, which are added, depending on the difference in the SP value, in the lower portion of the low refractive index layer can be confirmed by the method exemplified below.

The low refractive index layer is formed by applying, to a sample, the fluorine-containing binder polymer, organosilane sol compound having a vinyl polymerizable substituent and an initiator (1C-1) which will be described later, followed by curing. The surface of the sample is etched with Ar ions and the element composition of the surface is evaluated by ESCA. Repetition of this operation enables determination of the element distribution in the depth direction of the low refractive index layer. ESCA measurement is performed using “JPS-9000MX” (trade name; product of JOEL) and MgKα of 100W as an X-ray source and Ar ion etching is conducted under the conditions of 600V and 12.3 mA.

As a result of measurement, as will be described later in Examples, neither Si element derived from the organosilane sol compound nor Cl element derived from the initiator (1C-1) was detected from the surface of the low refractive index layer, but these elements in the layered form were detected from the back side of the low refractive index layer (lower layer of the low refractive index layer). TEM (transmission electron microscope) of a section of the sample has revealed that the low refractive index layer is composed of two layers. It has been elucidated from an increase in the thickness of the lower layer of the low refractive index layer resulting from an increase in the amount of the organosilane sol compound that the fluorine-containing binder polymer is present in the upper portion of the low refractive index layer, while the organosilane sol compound and the polymerization initiator of the invention are present locally in the lower portion of the low refractive index layer.

### (SP Value)

The SP value of a compound is its solubility parameter and it indicates how much the compound is soluble in a solvent. It has the same meaning as the term “polarity” frequently employed in the field related to organic compounds. The greater the SP value, the greater the polarity. The binder polymer of the low refractive index layer to be used in the invention is preferably a heat curable and/or ionizing radiation curable fluorine-containing polymer and its SP value as calculated by the Fedors method is, for example, 20 or less. The SP value of the above-described organosilane sol can be calculated similarly and the SP value of the organosilane sol using the sol solution b-1 to be used later in Examples of the invention is 22.4.

### [Polymerization Initiator]

Either a heat and/or light decomposable polymerization initiator may be used as the polymerization initiator present locally in the lower portion of the low refractive index layer in the invention insofar as it has an SP value greater than the binder polymer, especially the fluorine-containing binder polymer. The polymerization initiator may have, as a structure thereof, any of the below-described polymerization initiator skeletons. When the polymerization initiator has an SP value greater than that of the fluorine-containing binder polymer, the fluorine-containing binder polymer is present locally in the upper portion of the low refractive index layer. On the other hand, the polymerization initiator tends to be present locally in the lower portion of the low refractive index layer, which enables efficient progress of the polymerization of the curable compound also present in the lower portion of the low refractive index layer. The above-described SP value is calculated by, for example, the Fedors method.

A compound having, in the molecule thereof, such an initiator bound to the curable moiety of the curable compound has a similar effect when it has an SP value greater than that of the binder polymer.

### (Skeleton of Photo Radical Polymerization Initiator)

The skeleton of the photo radical polymerization initiator is not limited insofar as it is a compound similar to the photo radical polymerization initiator as exemplified in the section of “binder polymer for forming a hard coat layer” and at the same time, is an initiator having an SP value greater than that of the binder polymer for forming a low refractive index layer, especially that of the fluorine-containing binder polymer.

### (Skeleton of Thermal Radical Initiator)

The skeleton of the thermal radical initiator is also not limited insofar as it is a compound similar to the thermal radical polymerization initiator as exemplified in the section of “binder polymer for forming a hard coat layer” and at the same time, is an initiator having an SP value greater than that of the binder polymer for forming a low refractive index layer, especially that of the fluorine-containing binder polymer.

These initiators may be used either singly or in combination.

The initiators preferably usable in the invention and SP values thereof (calculated by the Fedors method) are shown below, but are not limited thereto.

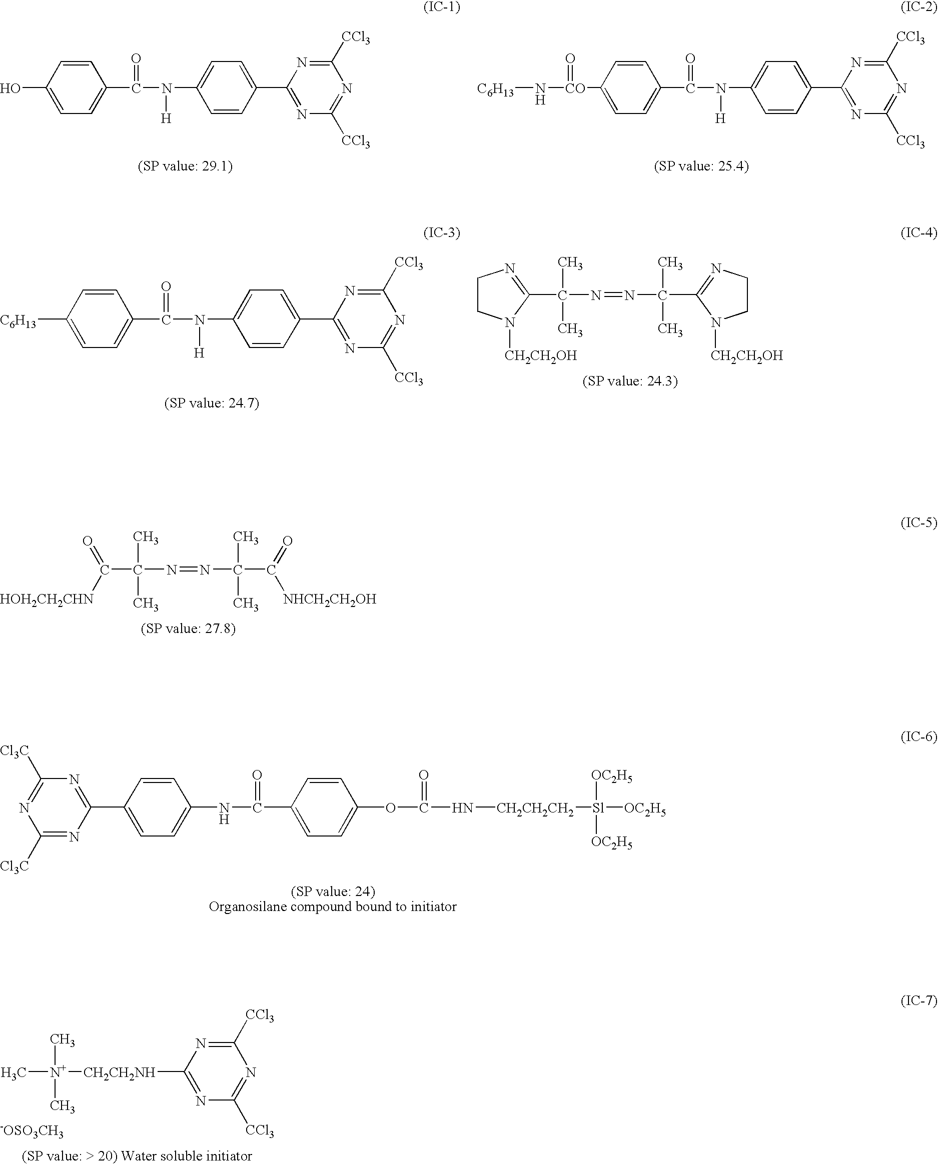

Examples of the self polymerization initiative curable compound having, in the molecule thereof, a polymerization initiator moiety bound to a curable compound having an ethylenically unsaturated group will next be shown.

(SP value: 25.7) Compound in which (IC-1) and polymerization initiator have been bound to each other

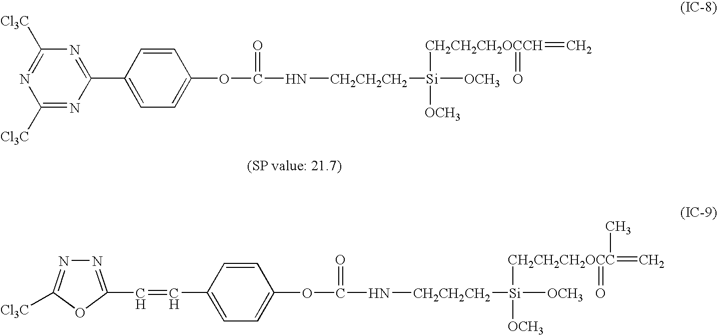

Specific compounds usable in the invention as an initiator will next be described.

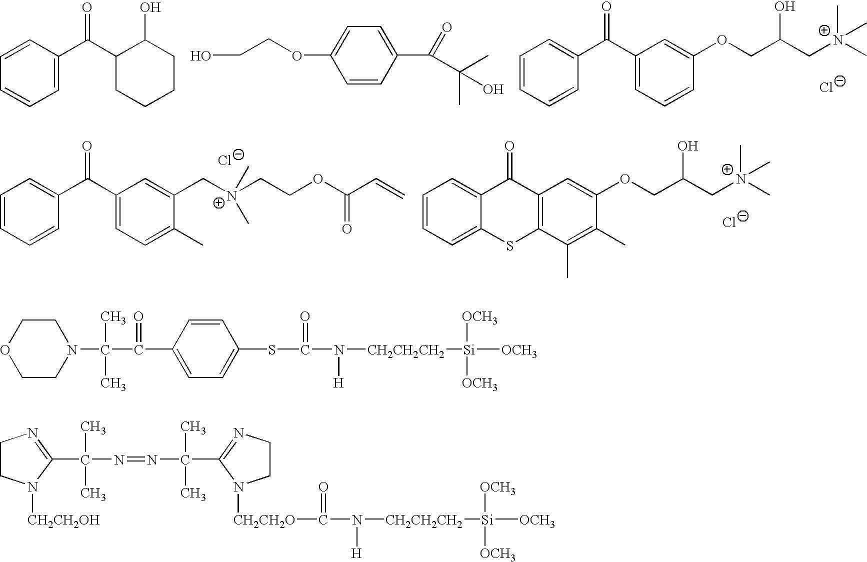

Although no particular limitation is imposed on the amount of the polymerization initiator, it is preferably from 0.1 to 20 parts by mass, more preferably from 1 to 10 parts by mass based on 100 parts by mass of the curable compound to be used in combination.

These polymerization initiator compounds may be used either singly or in combination or a photosensitizer or the like may be used in combination. Specific examples of the photosensitizer include n-butylamine, triethylamine, tri-n-butylphosphine, Michler's ketone and thioxanthone. Further, at least one of auxiliary agents such as azide compounds, thiourea compounds and mercapto compounds may be used in combination.

### [Antifouling Agent]

It is preferred to add, as needed, known compounds having a polysiloxane structure or known fluorine compounds as an antifouling agent, lubricant or the like for the purpose of imparting, to the antireflection film of the invention, particularly, to the low refractive index layer which is the uppermost layer thereof, various characteristics such as antifouling property, water resistance, chemical resistance and lubrication.

### (Compound Having a Polysiloxane Structure)

The above-described compound having a polysiloxane structure added to the low refractive index layer can impart thereto lubrication and improve the scratch resistance and antifouling property. No particular limitation is imposed on the structure of the compound and examples include compounds having a substituent at the terminal and/or in the side chain of the compound chain containing a plurality of dimethylsilyloxy units as a recurring unit. The compound chain containing dimethylsilyloxy as a recurring unit may further contain a structural unit other than dimethylsilyloxy.

Although no particular limitation is imposed on the molecular weight of the compound having a polysiloxane structure, it is preferably 100000 or less, especially preferably 50000 or less, most preferably from 3000 to 30000.

Antireflection films are usually put on the market in roll form after a protective film is attached thereto via an adhesive layer to protect their surface so that the compound having a polysiloxane structure and contained in the low refractive index layer tends to be transcribed to the adhesive layer or protective film, or the compound tends to transfer to a layer below the low refractive index layer such as high refractive index layer or hard coat layer. Incorporation, in the compound, of a hydroxyl group or a functional group capable of reacting with a hydroxyl group to form a bond is therefore preferred from the viewpoint of preventing such transcription or transfer.

The bond forming reaction preferably proceeds smoothly under heating conditions and/or in the presence of a catalyst. Such a substituent is, for example, an epoxy group or a carboxyl group. Preferred examples of the compounds having a polysiloxane structure are shown below but are not limited thereto.

### (Compounds Containing a Hydroxyl Group)

“X-22-160AS”, “KF-6001”, “KF-6002”, “KF-6003”, “X-22-170DX”, “X-22-176DX”, “X-22-176D” and “X-22-176F” (each, trade name; product of Shin-Etsu Chemical); “FM-4411”, “FM-4421”, “FM-4425”, “FM-0411”, “FM-0421”, “FM-0425”, “FM-DA11”; “FM-DA21” and “FM-DA25” (each, trade name; product of Chisso Corporation); “CMS-626” and “CMS-222” (each, trade name; product of Gelest)

### (Compounds Containing a Functional Group Reactive with a Hydroxyl Group)

“X-22-162C” and “KF-105” (each, trade name; product of Shin-Etsu Chemical); “FM-5511”, “FM-5521”, “FM-5525”, “FM-6611”, “FM-6621” and “FM-6625” (each, trade name; product of Chisso Corporation)

Another polysiloxane compound can be used in combination with the above-described polysiloxane compound. Preferred examples include compounds having a substituent at the terminal and/or in the side chain of the compound chain containing a plurality of dimethylsilyloxy units as a recurring unit. The compound chain containing dimethylsilyloxy as a recurring unit may contain a structural unit other than dimethylsilyloxy. Substituents may be the same or different and the compound has preferably a plurality of substituents. Preferred examples of the substituent include groups containing an acryloyl group, methacryloyl group, vinyl group, aryl group, cinnamoyl group, oxetanyl group, fluoroalkyl group, polyoxyalkylene group, carboxyl group or amino group.

The molecular weight of the compound is not particularly limited but is preferably 100000 or less, more preferably 50000 or less, especially preferably from 3000 to 30000, most preferably from 10000 to 20000.

The silicon atom content in the silicone compound is not particularly limited and is preferably 18.0 mass % or greater, especially preferably from 25.0 to 37.0 mass %, most preferably from 30.0 to 37.0 mass %.

### (Fluorine Compounds)

As the fluorine compound which will serve as an antifouling agent, fluoroalkyl-containing compounds are preferred. The fluoroalkyl group preferably has from 1 to 20 carbon atoms, more preferably from 1 to 10 carbon atoms. It may be linear {for example, —CF₂CF₃, —CH₂(CF₂)₄H, —CH₂(CF₂)₈CF₃, or —CH₂CH₂(CF₂)₄H}, branched {for example, CH(CF₃)₂, CH₂CF(CF₃)₂, CH(CH₃)CF₂CF₃, or CH(CH₃)(CF₂)₅CF₂H] or alicyclic (preferably a 5- or 6-membered ring, for example, a perfluorocyclohexyl group, perfluorocyclopentyl group or alkyl group substituted with such a group), or may have an ether bond (for example, CH₂OCH₂CF₂CF₃, CH₂CH₂OCH₂C₄F₈H, CH₂CH₂OCH₂CH₂C₈F₁₇, or CH₂CH₂OCF₂CF₂OCF₂CF₂H). A plurality of the fluoroalkyl groups may be contained in the same molecule.

These fluorine compounds preferably have further a substituent contributing to the bond formation or compatibility with the film of the low refractive index layer. The substituents may be the same or different. The compound has preferably a plurality of substituents. Examples of the preferred substituent include acryloyl, methacryloyl, vinyl, aryl, cinnamoyl, epoxy, oxetanyl, hydroxyl, polyoxyalkylene, carboxyl and amino groups.

The fluorine compound may be a polymer or oligomer with a fluorine-free compound and no particular limitation is imposed on the molecular weight of the fluorine compound. The fluorine atom content of the fluorine compound is not particularly limited but is preferably 20 mass % or greater, especially preferably from 30 to 70 mass %, most preferably from 40 to 70 mass %.

Preferred examples of the fluorine compound include, but are not limited to, “R-2020”, “M-2020”, “R-3833” and “M-3833” [each, trade name, product of Daikin Industries], and “MEGAFACE F-171” “MEGAFACE F-172”, “MEGAFACE F— 179A” and “DYFENSA MCF-300” [each, trade name, product of Dai-Nippon Ink & Chemicals].

When such an antifouling agent is added, it is added in an amount within a range of preferably from 0.01 to 20 mass %, more preferably from 0.05 to 10 mass %, especially preferably from 0.1 to 5 mass % of the total solid content of the low refractive index layer.

### [Dust Preventive, Antistatic Agent and the Like]

In order to impart properties such as dust resistance and antistatic property to the low refractive index layer, a dust preventive, antistatic agent or the like such as known cationic surfactant or polyoxyalkylene compound can be added as needed. The structural unit of such a dust preventive or antistatic agent may be contained in the above-described silicone compound or fluorine compound as a portion of its function.

When these additives are added, they are added in an amount of preferably from 0.01 to 20 mass %, more preferably from 0.05 to 10 mass %, especially preferably from 0.1 to 5 mass %, each of the total solid content of the low refractive index layer. Examples of the preferred compound include, but not limited to, “MEGAFACE F-150” (trade name; product of Dainippon Ink & Chemicals) and “SH-3748” (trade name; product of Dow Corning Toray Silicone).

### [Metal Oxide Particles]

As the metal oxide particles to be used for the low refractive index layer, those having a low refractive index are preferably employed. Silica particles and hollow silica particles are preferred as the metal oxide particles, with hollow silica particles being especially preferred. The average particle size of the metal oxide particles is preferably 1 nm or greater but not greater than 1 μm, more preferably from 1 nm to 200 nm, still more preferably from 1 nm to 100 nm, especially preferably from 1 nm to 80 nm. The particle size of the metal oxide particles is preferably as uniform (monodisperse) as possible.

### (Silica Particles)

The average particle size of silica particles is preferably 30% or greater but not greater than 150%, more preferably 35% or greater but not greater than 80%, still more preferably 40% or greater but not greater than 60%, each of the thickness of the low refractive index layer. In other words, when the low refractive index layer has a thickness of 100 nm, the particle size of silica particles is preferably 30 nm or greater but not greater than 150 nm, more preferably 35 nm or greater but not greater than 80 nm, still more preferably 40 nm or greater but not greater than 60 nm. When the particle size of silica particles is the lower limit or greater, they are effective for improving the scratch resistance. When it is not greater than the upper limit, on the other hand, there does not arise any troubles such as deterioration in appearance such as clear blackness or deterioration in integral reflectance owing to minute irregularities formed on the surface of the low refractive index layer. The average particle sizes within the above-described range are therefore preferred.

The silica particles may be either crystalline or amorphous. They may be monodisperse particles, or if they have a predetermined particle size, they may be aggregated particles. Their shape is most preferably spherical, but amorphous particles do not cause any troubles. The average particle size of the silica particles is measured by a Coulter counter.

### (Hollow Silica Particles)

In order to lower the refractive index of the low refractive index layer, use of hollow silica particles is preferred. The refractive index of the hollow silica particles is preferably from 1.15 to 1.40, more preferably from 1.17 to 1.35, most preferably from 1.17 to 1.30. The term “refractive index” as used herein means a refractive index of the particle as a whole and does not mean a refractive index of the outer shell silica forming the hollow silica particle. When the diameter of the void in the particle is rᵢ and the diameter of the outer shell of the particle is rₒ, the void fraction x is represented by the following equation (2). The void fraction x of the hollow silica particle is preferably from 10 to 60%, more preferably from 20 to 60%, most preferably from 30 to 60%.

x=(4πrᵢ³/3)/(4πrₒ³/3)×100. Equation (2):

Particles having a refractive index of 1.15 or greater have a sufficiently thick outer shell and therefore have an increased strength so that they are preferred from the viewpoint of scratch resistance.

Preparation processes of hollow silica particles are described, for example, in JP-A-2001/233611 and JP-A-2002/79616. Hollow particles in which pores of the shell have been occluded are particularly preferred. The refractive index of such hollow silica particles can be calculated by the method described in JP-A-2002/079616.

The hollow silica particles are applied preferably in an amount of from 1 mg/m² to 100 mg/m², more preferably from 5 mg/m² to 80 mg/m², more preferably from 10 mg/m² to 60 mg/m². When the application amount of them is the lower limit or greater, they are effective for decreasing the refractive index or improving the scratch resistance. When the application amount is not greater than the upper limit, on the other hand, they does not arise any troubles such as deterioration in appearance such as clear blackness or deterioration in integral reflectance owing to minute irregularities formed on the surface of the low refractive index layer. The application amounts within the above-described range are therefore preferred.

The average particle size of the hollow silica particles is preferably 30% or greater but not greater than 150%, more preferably 35% or greater but not greater than 80%, still more preferably 40% or greater but not greater than 60%, each of the thickness of the low refractive index layer. In other words, when the low refractive index layer has a thickness of 100 nm, the particle size of the hollow silica particles is preferably 30 nm or greater but not greater than 150 nm, more preferably 35 nm or greater but not greater than 100 nm, still more preferably 40 nm or greater but not greater than 65 nm. When the particle size of the hollow silica particles is the lower limit or greater, they are effective for decreasing the refractive index because a ratio of void portions does not become too small. When it is not greater than the upper limit, on the other hand, there does not arise any troubles such as deterioration in appearance such as clear blackness or deterioration in integral reflectance owing to minute irregularities formed on the surface of the low refractive index layer. The average particle sizes within the above-described range are therefore preferred.

The hollow silica particles may be either crystalline or amorphous. They are preferably monodisperse particles. Their shape is most preferably spherical, but even hollow silica particles having an amorphous shape do not cause any troubles.

Two or more kinds of hollow silica particles different in average particle size may be used in combination. The average particle size can be determined from an electron micro graph.

In the invention, the specific surface are of the hollow silica particles is preferably from 20 to 300 m²/g, more preferably from 30 to 120 m²/g, most preferably from 40 to 90 m²/g. The surface area can be determined by the BET method while using nitrogen.

In the invention, hollow silica particles may be used in combination with voidless silica particles. The particle size of the voidless silica particles is preferably 30 nm or greater but not greater than 150 nm, more preferably 35 nm or greater but not greater than 100 nm, most preferably 40 nm or greater but not greater than 80 nm.

At least one kind of silica particles (which will be called “silica particles with small particle size) having an average particle size less than 25% of the thickness of the low refractive index layer may be used in combination with silica particles (which will be called “silica particles with large particle size”) having the above-described particle size.

The silica particles with small particle size can be present in a space between the silica particles with large particle size so that they can contribute as a retention agent of the silica particles with a large particle size.

The average particle size of the silica particles with a small particle size is preferably 1 nm or greater but not greater than 20 nm, more preferably 5 nm or greater but not greater than 15 nm, especially preferably 10 nm or greater but not greater than 15 nm. Use of such silica particles is preferred from the standpoints of raw material cost and an effect as a retention agent.

### (Surface Modification)

The silica particles or hollow silica particles may be subjected to physical surface treatment such as plasma discharge treatment or corona discharge treatment or chemical surface treatment with a surfactant or coupling agent in order to attain dispersion stabilization or heighten affinity or binding property with binder components in a dispersion or coating solution. In particular, they are preferably surface-modified with a compound having hydrolyzable silicon. Such a surface treatment agent may be added in an amount of from 0.1 to 100 mass %, more preferably from 1.0 to 50 mass %, especially preferably from 5.0 to 35 mass %, relative to these silica particles.

As the coupling agent, alkoxymetal compounds (such as titanium coupling agent and silane coupling agent) are preferred. In particular, at least one of the above-described silica particles and hollow silica particles are preferably surface treated with an organosilane compound represented by the following formula (a):

(R₁₁)ₘ₁—SiX¹¹₄₋ₘ₁ Formula (a):

In the above formula (a), R¹¹ represents a substituted or unsubstituted alkyl group or a substituted or unsubstituted aryl group. The alkyl group is, for example, methyl, ethyl, propyl, isopropyl, hexyl, decyl, hexadecyl or the like. The alkyl group is preferably a C₁₋₃₀, more preferably a C₁₋₁₆, especially preferably a C₁₋₆ alkyl group. The aryl group is, for example, phenyl, naphthyl or the like, with phenyl being preferred.

X¹¹ is a hydroxyl group or a hydrolyzable group and it is preferably an alkoxy group (preferably a C₁₋₅ alkoxy such as methoxy or ethoxy), halogen atom (such as Cl, Br or I) or R¹²COO(R¹² is preferably a hydrogen atom or a C₁₋₅ alkyl group so examples of R¹²COO include CH₃COO and C₂H₅COO). X¹¹ is more preferably an alkoxy group, especially preferably a methoxy or ethoxy group.

“m1” stands for an integer of from 0 to 3, preferably 1 or 2.

When a plurality of R¹¹'s or X¹¹'s are present, the plurality of R¹¹s or the plurality of X¹¹s may be the same or different.

No particular limitation is imposed on the substituent contained in R¹¹. Examples include halogen atoms (such as fluorine, chlorine and bromine), hydroxyl group, mercapto group, carboxyl group, epoxy group, alkyl groups (such as methyl, ethyl, i-propyl, propyl and t-butyl), aryl groups (such as phenyl and naphthyl), aromatic heterocyclic groups (such as furyl, pyrazolyl and pyridyl), alkoxy groups (such as methoxy, ethoxy, i-propoxy and hexyloxy), aryloxy groups (such as phenoxy), alkylthio groups (such as methylthio and ethylthio), arylthio groups (such as phenylthio), alkenyl groups (such as vinyl and 1-propenyl), acyloxy groups (such as acetoxy, acryloyloxy and methacryloyloxy), alkoxycarbonyl groups (such as methoxycarbonyl and ethoxycarbonyl), aryloxycarbonyl groups (such as phenoxycarbonyl), carbamoyl groups (such as carbamoyl, N-methylcarbamoyl, N,N-dimethylcarbamoyl and N-methyl-N-octylcarbamoyl) and acylamino groups (such as acetylamino, benzoylamino, acrylamino and methacrylamino). These substituents may be substituted further.

When a plurality of R¹¹s are present, at least one of them is preferably a substituted alkyl group or a substituted aryl group.

In the invention, the organosilane compound to be especially preferred is preferably an organosilane compound represented by the formula (a) and having a vinyl polymerizable substituent. Moreover an organosilane compound of the formula (a) having as R¹¹ a (meth)acryloyl group, in other words, an organosilane compound of the formula (a) in which R¹¹ contains a (meth)acryloyl group as a substituent thereof is especially preferred.

An organosilane compound of the formula (a) having as R¹¹ an epoxy-containing group, in other words, an organosilane compound of the formula (a) in which R¹¹ contains an epoxy group as a substituent can also be especially preferred.

In order to reduce the burden of surface treatment, the silica particles have preferably been dispersed in a medium in advance. The specific compounds of the surface treatment agents and catalysts preferably usable in the invention are, for example, organosilane compounds and catalysts described in, for example, WO04/017105.

For the low refractive index layer, two kinds of metal oxide particles different in particle size may be used in combination. The low refractive index layer can have both desired reflectance and scratch resistance by using, in combination, metal oxide particles having a particle size of from 20 nm to 80 nm and metal oxide particles having a particle size of from 20 nm or less. A ratio of the amounts of these two kinds of metal oxide particles different in particle can be changed freely between from 0 to 1, depending on the balance between the desired reflectance and scratch resistance. A reduction in the reflectance can be attained by increasing a ratio of the metal oxide particles having a smaller particle size, while improvement in scratch resistance can be attained by increasing a ratio of the metal oxide particles having a larger particle size.

The metal oxide particles are preferably added in an amount of from 5 to 90 mass %, more preferably from 10 to 70 mass %, especially preferably from 10 to 50 mass % based on the total mass of the low refractive index layer.

### [Dispersion Stabilizer]

In the invention, use of a dispersion stabilizer in combination is preferred in order to suppress aggregation and precipitation of the metal oxide particles in the low refractive index layer. For this purpose, dispersion stabilizers similar to those used for the hard coat layer may be used by the similar method. The preferred amount of it is also similar.

### [Solvent of a Coating Solution for Forming Each Layer]

For preparing a coating solution for forming the hard coat layer or low refractive index layer of the invention, either a single solvent or a mixture of solvents may be used. When a mixture of solvents is used, the amount of solvents having a boiling point of 100° C. or less is preferably from 50 to 100 mass %, more preferably from 80 to 100 mass %, still more preferably from 90 to 100 mass %, still more preferably 100 mass % of the total amount of the solvents. When the amount of the solvents having a boiling point not greater than 100° C. is contained in an amount equal to or greater than the lowest limit, excessive delay in the drying speed can be suppressed, and neither worsening of the coated surface condition nor unevenness in the coated film thickness occurs. As a result, there does not arise any trouble such as worsening of optical properties including reflectance. These troubles can be overcome by using a coating solution rich in a solvent having a boiling point of 100° C. or less.

Examples of the solvent having a boiling point not greater than 100° C. include hydrocarbons such as hexane (boiling point: 68.7° C. (“° C.” will hereinafter be omitted), heptane (98.4), cyclohexane (80.7) and benzene (80.1), halogenated hydrocarbons such as dichloromethane (39.8), chloroform (61.2), carbon tetrachloride (76.8), 1,2-dichloroethane (83.5), and trichloroethylene (87.2), ethers such as diethyl ether (34.6), diisopropyl ether (68.5), dipropyl ether (90.5), and tetrahydrofuran (66), esters such as ethyl formate (54.2), methyl acetate (57.8), ethyl acetate (77.1), and isopropyl acetate (89), ketones such as acetone (56.1) and 2-butanone (methyl ethyl ketone=MEK, 79.6), alcohols such as methanol (64.5), ethanol (78.3), 2-propanol (82.4), and 1-propanol (97.2), cyano compounds such as acetonitrile (81.6) and propionitrile (97.4), and carbon disulfide (46.2). Of these, ketones and the esters are preferred and ketones are especially preferred. Of the ketones, 2-butanone is especially preferred.

Examples of the solvent having a boiling point of 100° C. or greater include octane (125.7), toluene (110.6), xylene (138), tetrachloroethylene (121.2), chlorobenzene (131.7), dioxane (101.3), dibutyl ether (142.4), isobutyl acetate (118), cyclohexanone (155.7), 2-methyl-4-pentanone (methyl isobutyl ketone=MIBK, 115.9), 1-butanol (117.7), N,N-dimethylformamide (153), N,N-dimethylacetamide (166), and dimethylsulfoxide (189). Of these, cyclohexanone and 2-methyl-4-pentanone are preferred.

The coating solutions for forming the hard coat layer and low refractive index layer of the invention can be prepared by diluting their components with the solvent having the above-described composition. The concentration of each of the coating solutions is preferably adjusted in consideration of the viscosity of the coating solution or specific gravity of the materials constituting each layer, but it is preferably from 0.1 to 20 mass %, more preferably from 1 to 10 mass %.

### [Transparent Support]

As the transparent support of the antireflection film of the invention, a plastic film is used preferably. Examples of a polymer forming the plastic film include cellulose esters (for example, triacetyl cellulose and diacetyl cellulose, typically “TAC-TD80U” and “TAC-TD80UF (each, trade name; product of Fujifilm), polyamides, polycarbonates, polyesters (for example, polyethylene terephthalate and polyethylene naphthalate), polystyrenes, polyolefins, norbornene resins (“Arton” (trade name, product of JSR), and amorphous polyolefins (“Zeonex” (trade name, product of Nippon Zeon). Of these, triacetyl cellulose, polyethylene terephthalate, and polyethylene naphthalate are preferred, with triacetyl cellulose being especially preferred.

A triacetyl cellulose film is composed of a single layer or plural layers. The monolayer cellulose acylate film is prepared by drum casting, band casting or the like method as disclosed in JP-A-7-11055, while the multilayer triacetyl cellulose film is prepared by the so-called co-casting method disclosed, for example, in JP-A-61-94725 or JP-B-62-43846.

Described specifically, the film is prepared by dissolving raw material flakes in a solvent such as halogenated hydrocarbon (such as dichloromethane), alcohol (such as methanol, ethanol, or butanol), ester (such as methyl formate or methyl acetate), or ether (such as dioxane, dioxolane, or diethyl ether); adding if necessary various additives such as plasticizer, ultraviolet absorber, deterioration preventive, lubricant or peeling accelerator to the resulting solution; casting the resulting mixture (which will be called “dope”) on a substrate made of a horizontal endless metal belt or a rotating drum by dope supply means (which will be called “die”), more specifically, performing single-layer casting of the dope if a monolayer film is formed and co-casting of a low-concentration dope on both sides of a high-concentration cellulose ester dope if a multilayer film is formed; peeling, from the substrate, the film imparted with rigidity by drying to a certain extent on the substrate; and passing the film through a drying section by conveyor means, thereby removing the solvent.

Dichloromethane is a typical solvent for dissolving therein triacetyl cellulose. In consideration of a global environment or a work environment, however, the solvent is preferably substantially free of a halogenated hydrocarbon such as dichloromethane. The term “substantially free” as used herein means that a ratio of the halogenated hydrocarbon in the organic solvent is less than 5 mass % (preferably less than 2 mass %). When a dope of triacetyl cellulose is prepared using a solvent substantially free of dichloromethane or the like, a special dissolving method as described below is indispensable.

A first dissolving method is called “cooling dissolution method” which will be described next.

First, under stirring, triacetyl cellulose is added in portions to a solvent at a temperature near the room temperature (−10 to 40° C.). The mixture is then cooled to from −100 to −10° C. (preferably from −80 to 10° C., more preferably from −50 to −20° C., most preferably from −50 to −30° C.). The cooling is conducted for example in a dry ice-methanol bath (−75° C.) or a cooled diethylene glycol solution (from −30 to −20° C.). The mixture of triacetyl cellulose and solvent solidifies by such cooling. It is then heated to a temperature of from 0 to 200° C. (preferably from 0 to 150° C., more preferably from 0 to 120° C., most preferably from 0 to 50° C.) to convert it into a solution in which cellulose acylate flows in the solvent. The temperature is elevated by leaving the mixture at room temperature, or by heating in a warm bath.

A second dissolution method is called “high-temperature dissolution method” and it will be described next.

First, triacetyl cellulose is added in portions to a solvent under stirring at a temperature near the room temperature (from −10 to 40° C.). The triacetyl cellulose solution to be used in the invention is preferably prepared by adding triacetyl cellulose to a mixed solvent containing various solvents and swelling it therewith in advance. In this method, the concentration of triacetyl cellulose in the solution is preferably 30 mass % or less, but is preferably as high as possible in consideration of the drying efficiency at the time of film formation. The resulting mixture is then heated to a range of from 70 to 240° C. (preferably from 80 to 220° C., more preferably from 100 to 200° C., most preferably from 100 to 190° C.) under pressure of from 0.2 to 30 MPa. The heated solution must then be cooled to not greater than the boiling point of the solvent having the lowest boiling point among the solvents employed, because the heated solution cannot be applied as is. It is the common practice to cool the solution to a range of from −10 to 50° C. to reduce the pressure to normal pressure. The cooling can be achieved by leaving a high-pressure high-temperature container or a line, having the triacetyl cellulose solution therein, at room temperature or by cooling the apparatus with a coolant such as cooling water.

A cellulose acylate film substantially free of a halogenated hydrocarbon such as dichloromethane and a preparation process thereof are described in the Laid-open Technical Report of the Japan Institute of Invention and Innovation (Technical Report No. 2001-1745, issued Mar. 15, 2001, which will hereinafter be abbreviated as Laid-open Technical Report 2001-1745).

### [Formation of Antireflection Film]

Each layer of the antireflection film composed of a plurality of layers can be formed by application using dip coating, air knife coating, curtain coating, roller coating, die coating, wire bar coating, gravure coating or extrusion coating method (refer to U.S. Pat. No. 2,681,294). Of these methods, use of die coating method is preferred and use of a novel die coater which will be described later is more preferred. Two or more layers may be formed by the simultaneous application. The method of simultaneous application is described in U.S. Pat. Nos. 2,761,791, 2,941,898, 3508947 and 3526528, and Yuji Harasaki, Coating Kogaku (Coating Engineering), page 253, Asakura Shoten (1973).

The antireflection film of the invention can be produced continuously by the steps of, for example, continuously unwinding a substrate film (transparent support) in roll form, applying a coating solution thereto and drying, curing the coating, and taking up the substrate film having a cured layer.

These steps will next be described more specifically.

The substrate film in roll form is unwound continuously in a clean room. In the clean room, static electricity is removed from the substrate film by using an ionizer. Then, foreign matters attached onto the substrate film are removed by a dust arrester. A coating solution is then applied onto the substrate film at a coating section in the clean room and the resulting substrate film is sent to a drying chamber for drying.

The dried substrate film having a coated layer thereon is sent to a heat curing section from the drying chamber. After heat curing, it is sent to a radiation curing chamber and exposed to radiation. The polymerization of the monomer contained in the coated layer occurs, which leads to the curing of the coated layer. In some cases, the film is directly sent to the radiation curing chamber, where the monomer contained in the coating layer is polymerized by exposure to radiation and curing is completed. The substrate film having the completely cured layer thereon is taken up into a roll.

In the invention, die coating method is preferred as a coating method from the viewpoint of higher production rate. The die coating method is preferred because both a productivity and surface condition free from coating unevenness can be accomplished at a high level.

The process of the invention for producing an optical film having, on a transparent support, at least two layers containing cured products comprises applying the below-described composition (I) to the transparent support as a layer to be brought into contact with the surface of the transparent support, drying and then curing the composition by heating and/or exposing to ionizing radiation in an atmosphere having an oxygen concentration of 3 vol. % or less; and applying the below-described composition (II) as an outermost layer of the optical film, drying and curing the composition by heating and/or exposing to ionizing radiation in an atmosphere having an oxygen concentration of 3 vol. % or less:

Composition (I): a composition having a polyfunctional compound (a) having two or more ethylenically unsaturated groups, a thermo- and/or photo-polymerization initiator and metal oxide particles.

Composition (II): a composition having a binder polymer, (b) a polyfunctional compound having two or more ethylenically unsaturated groups, a photo- and/or thermo-polymerization initiator and metal oxide particles.

### [Curing Method of Coating]

In the invention, the coating may be cured by direct exposure to ionizing radiation after drying or cured under heat after drying, followed by exposure to ionizing radiation, or when only a thermopolymerization initiator is added, the coating may only be cured under heat after drying. Of these curing methods, curing by exposure to ionizing radiation is preferably performed by exposing the coating to ionizing radiation in an atmosphere having an oxygen concentration of 3 vol. % or less and at the same time maintaining this atmosphere having an oxygen concentration of 3 vol. % of less for 0.5 second after the exposure to ionizing radiation is started. By supplying an inert gas to the irradiation chamber of ionizing radiation and at the same time controlling so that the inert gas may slightly blow out on the web inlet side in the irradiation chamber, it is possible to avoid entering of the air induced by web transport, effectively reduce the oxygen concentration in the reaction chamber and efficiently lower the substantial oxygen concentration on the immediate surface whose curing will otherwise be greatly disturbed by oxygen. Flowing direction of the inert gas on the web inlet side in the irradiation chamber can be controlled by adjusting charge and discharge balance of air in the irradiation chamber.

Direct spraying of the inert gas to the web surface is also preferred as a method for removing the air induced by web transport. The low refractive index layer which constitutes the outermost layer and has a thin film thickness is preferably cured by this method.

Further, the coating can be cured more efficiently by providing an anterior chamber in front of the reaction chamber, thereby removing the oxygen from the surface of the web in advance. Further, a gap between the web surface and the side surface constituting the web inlet side of the ionization radiation reaction chamber or anterior chamber is preferably from 0.2 to 15 mm, more preferably from 0.2 to 10 mm, most preferably from 0.2 to 5 mm for the efficient use of the inert gas.

When a continuous web is formed, however, it is necessary to join and connect webs. A method of adhering webs each other with a bonding tape is widely employed for joining them. An excessively small gap between the inlet of the ionizing radiation reaction chamber or the anterior chamber and the web will pose a problem that a bonding member such as bonding tape may be caught. In order to decrease the gap width, it is preferred to make movable at least a portion of the inlet of the ionizing radiation reaction chamber or the anterior chamber in the traveling direction and widen the gap by a joined thickness when the joined portion of the web passes through the chamber. Such a structure can be actualized by making movable the inlet of the ionizing radiation reaction chamber or the anterior chamber back and forth in the traveling direction so that it moves back and forth, thereby widening the gap when the joined portion passes through the chamber, or by making movable the inlet of the ionizing radiation reaction chamber or the anterior chamber in a direction vertical to the web surface so that it moves up and down, thereby widening the gap when the joined portion passes through the chamber.

The oxygen concentration in the atmosphere upon exposure to ionizing radiation is 3 vol. % or less, preferably 1 vol. % or less, more preferably 0.5 vol. % or less. A large amount of an inert gas such as nitrogen is necessary for reducing the oxygen concentration so that it is preferred not to reduce the oxygen concentration excessively from the viewpoint of the production cost. As means for reducing the oxygen concentration, preferred is the substitution of an atmosphere (nitrogen concentration: about 79 vol. %, oxygen concentration: about 21 vol. %) with another inert gas, especially preferably with nitrogen (nitrogen purging).

In the invention, it is preferred that at least one layer stacked over the transparent substrate is exposed to ionizing radiation in an atmosphere having an oxygen concentration of 3 vol. % or less and at the same time, it is retained in the atmosphere having an oxygen concentration of 3 vol. % or less for 0.5 second or greater after the initiation of the exposure to ionization radiation. It is retained in the low oxygen concentration atmosphere preferably for 0.7 second or greater but not greater than 60 seconds, more preferably 0.7 second or greater but not greater than 10 seconds. The low oxygen concentration is maintained preferably for 0.5 second or greater because if so, curing reaction proceeds sufficiently and sufficient curing can be accomplished. On the other hand, the low oxygen concentration is maintained preferably for 60 seconds or less, because maintenance of such an atmosphere for a long time inevitably requires large equipment and a large amount of an inert gas.

In the invention, at least one layer stacked over the transparent substrate can be cured by ionizing radiation performed a plurality of times. In this case, exposure to ionizing radiation is preferably conducted at least twice in continuous reaction chambers having an oxygen concentration not exceeding 20 vol. %. It is possible to effectively secure the reaction time necessary for curing by performing exposure to ionizing radiation a plurality of times in the reaction chambers having the same low oxygen concentration. In particular when the production rate is raised for securing high productivity, it is preferred to perform exposure to ionization radiation a plurality of times to ensure the energy of ionizing radiation necessary for curing reaction. The above-described mode is effective as well as the securing of the reaction time necessary for the curing reaction.

Although no particular limitation is imposed on the kind of the ionizing radiation in the invention, it is selected as needed from ultraviolet light, electron beam, near ultraviolet light, visible light, near infrared light, infrared light and X ray, depending on the kind of the curing composition for forming a coating. Of these, exposure to ultraviolet light is preferred in the invention, because of high polymerization speed which leads to the scale down of the equipment, many choices from which a proper compound can be selected, and low cost.

For the exposure to ultraviolet light, an extra high pressure mercury lamp, high pressure mercury lamp, low pressure mercury lamp, carbon arc lamp, xenon arc lamp, and metal halide lamp can be used. For the exposure to electron beam, electron beam having an energy of from 50 to 1000 keV emitted from various electron accelerators such as Cockcroft-Walton accelerator, Van de Graaff accelerator, resonant transforming accelerator, insulating core-transforming accelerator, linear accelerator, dinamitron, and radio-frequency accelerator can be used.

### [Use of Antireflection Film]

When the antireflection film of the invention is used for a display device, for example, a liquid crystal display device, it may be disposed on the outermost surface of the display device by having an adhesive layer on one side of the film. As a protective film for protecting a polarization film of a polarizing plate, a triacetyl cellulose film is often employed. When the transparent support of the antireflection film of the invention is a triacetyl cellulose film, the antireflection film is preferably used as is as the protective film from the viewpoint of a cost.

### [Saponification Treatment]

When the antireflection film of the invention is disposed on the outermost surface of a display device by having an adhesive layer on one side of the film or is used as is as a protective film for a polarizing plate, it is preferred to perform saponification treatment after the formation of the outermost layer on the transparent support.

The saponification treatment is performed in a known manner, for example, by dipping the antireflection film in an alkali solution for adequate time. After dipping in the alkali solution, the film is rinsed with water sufficiently or the alkali component is neutralized by dipping in a dilute acid so as to avoid the alkali component from remaining in the film. By the saponification treatment, the surface of the transparent support on the side opposite to the side having the outermost layer is hydrophilized.

The hydrophilized surface is particularly effective for improving the adhesion with a polarization film composed mainly of polyvinyl alcohol. In addition, the hydrophilized surface is effective for preventing point defects due to dusts, because dusts in the air do not readily adhere to the hydrophilized surface and entering of dusts between the polarization film and antireflection film can be prevented when they are adhered each other.

The saponification treatment is effected so that the contact angle, against water, of the surface of the transparent support on the side opposite to the side having the outermost layer will be 40° or less, more preferably 30° or less, especially preferably 20° or less.

Alkali saponification treatment can be performed by a method selected from the below-described two methods. The method (1) is superior because the antireflection film and an ordinarily used triacetyl cellulose film can be treated in one step. This method is however not free from problems, because saponification extends even to the surface of the antireflection film so that the film surface is deteriorated by the alkali hydrolysis; and the saponification treatment solution remains as a stain. In this case, the below-described method (2) is superior, though it requires a special step.

(1) After formation of an antireflection coating on a transparent support, the back side of the resulting film is saponified by dipping at least once in an alkali solution.

(2) Before or after the formation of an antireflection coating on a transparent support, an alkali solution is applied onto a surface of the resulting antireflection film opposite to the surface on which the antireflection coating is formed, followed by heating and washing with water and/or neutralization, whereby only the back side of the film is saponified.

### [Use of Antireflection Film]

### [Polarizing Plate]

A polarizing plate is composed mainly of two protective films sandwiching a polarization film therebetween. The antireflection film of the invention is preferably employed as at least one of the two protective films sandwiching the polarization film therebetween. Use of the antireflection film of the invention as a protective film enables reduction in the production cost of the polarizing plate. In addition, use of the antireflection film of the invention as the outermost layer makes it possible to form a polarizing plate free from reflection of external light and excellent in scratch resistance, antifouling property and the like.

### [Polarization Film]

As the polarization film, a known polarization film or a polarization film cut out from a long polarization film with the absorption axis thereof being neither parallel nor perpendicular to the longitudinal direction may be used. The long polarization film with the absorption axis thereof being neither parallel nor perpendicular to the longitudinal direction is produced by the following method.

The polarization film is obtained by stretching a continuously fed polymer film under application of a tension while holding both ends of the film by holding means. Described specifically, it can be produced by a stretching method in which the film is stretched at least in the width direction of the film at a draw ratio of from 1.1 to 20.0; a difference in the traveling speed in the longitudinal direction between the holding devices on both ends of the film is within 3%; and the film traveling direction is bent while holding the both ends of the film in such a manner that the angle made between the film traveling direction at the outlet in the step of holding both ends of the film and the substantial stretching direction of the film is inclined by from 20 to 70°.

The stretching method of the polymer film is described in detail in Paragraphs from [0020] to [0030] of JP-A-2002-86554.

Of the two protective films of the polarization film, the film other than the antireflection film is preferably an optically compensatory film having an optically anisotropic layer. The optically compensatory film (retardation film) can improve the viewing angle properties of a liquid crystal display screen. As the optically compensatory film, known ones are usable, but an optically compensatory film described in JP-A-2001-100042 is preferred from the viewpoint of widening the viewing angle.

### [Display Device]

The antireflection film of the invention is used for a display device such as liquid crystal display device (LCD), plasma display panel (PDP), electroluminescence display (ELD) and cathode ray tube display device (CRT).

### [Liquid Crystal Display Device]

The optical film, antireflection film, and polarizing plate using the film in the invention can be used advantageously for a display device such as liquid crystal display device. Use of it as the outermost layer of the display is preferred.

In the display device, the layer (preferably, low refractive index layer) containing a cured product of the composition (II) of the optical film, antireflection film or polarizing plate is preferably laid on the viewer side.

A liquid display device has a liquid crystal cell and two polarizing plates provided on both sides thereof. The liquid crystal cell has a liquid crystal between two electrode substrates. Further, one optically anisotropic layer may be disposed between the liquid crystal cell and one of the polarizing plate or two optically anisotropic layers may be disposed between the liquid crystal cell and one of the two polarizing plates and between the liquid crystal cell and the other polarizing plate.

The liquid crystal cell is preferably any one of TN mode, VA mode, OCB mode, IPS mode and ECB mode.

### [TN Mode]

In the TN mode liquid crystal cell, rod-shaped liquid crystalline molecules are aligned substantially horizontally when no voltage is applied and shows twisted orientation by from 60 to 120°.

The TN mode liquid crystal cell is most frequently employed for a color TFT liquid crystal display device and it is described in many documents. (VA mode) In a VA mode liquid crystal cell, rod-like liquid crystal molecules are substantially vertically oriented when no voltage is applied.

VA mode liquid crystal cells include, in addition to (1) a liquid crystal cell in a VA mode in a narrow sense in which rod-like liquid crystal molecules are oriented substantially vertically when no voltage is applied but are oriented substantially horizontally when a voltage is applied (as disclosed in JP-A-2-176625),

(2) a liquid crystal cell in a VA mode which is multidomained to expand the viewing angle (MVA mode) (as disclosed in SID97, Digest of Tech. Papers (preprint) 28 (1997), 845),

(3) a liquid crystal cell of a mode in which rod-like molecules are oriented substantially vertically when no voltage is applied but oriented in a twisted multidomained manner when a voltage is applied (n-ASM mode) (as disclosed in Preprints of Symposium on Japanese Liquid Crystal Society Nos. 58 to 59, 1998, and

(4) a liquid crystal cell of a SURVAIVAL mode (as reported in LCD International 98).

### (OCB Mode)

An OCB mode liquid crystal cell is a liquid crystal cell of a bend alignment mode wherein rod-like liquid crystal molecules in the upper part and lower part of the liquid crystal cell are oriented in substantially opposing directions (symmetrically) each other. It is disclosed in U.S. Pat. Nos. 4,583,825 and 5,410,422. Since the rod-like liquid crystal molecules in the upper part and lower part of the liquid crystal cell are oriented symmetrically each other, the bend alignment mode liquid crystal cell has a self optical compensation capacity. Accordingly, this liquid crystal mode is also called OCB (optically compensated bend) liquid crystal mode. The bend alignment mode liquid crystal display device is advantageous in that it has a high response.

### (IPS Mode)

The IPS mode liquid crystal cell employs a system of switching a nematic liquid crystal by applying a transverse electric field thereto, which is described in detail in Proc. IDRC (Asia Display '95), pp. 577-580 and pp. 707-710.

### (ECB Mode)

In the ECB mode liquid crystal cell, rod-like liquid crystal molecules are oriented substantially horizontally when no voltage is applied thereto. The ECB mode is one of liquid crystal display modes having the simplest structure and is described, for example, in JP-A-5-203946.

### [Display Other than Liquid Crystal Display Device]

### (PDP)

A plasma display panel (PDP) is usually composed of a gas, glass substrates, electrodes, electrode lead material, thick film printing material, and phosphor. The glass substrates are front glass substrate and back glass substrate. These two glass substrates have an electrode and insulating layer formed thereover. The back glass substrate has further a phosphor layer formed thereover. The two glass substrates are assembled and the gas is enclosed therebetween.

A plasma display panel (PDP) is commercially available, and is described in JP-A-5-205643 and JP-A-9-306366.

In front of the plasma display panel, a front plate may be provided. The front plate is preferably strong enough to protect the plasma display panel. The front plate may be used with a space disposed between the plate and the plasma display panel or may be directly laminated on the plasma display panel itself.

In a display device such as a plasma display panel, the antireflection film of the invention may be directly laminated on the surface of the display as an optical filter. When the display has, in front thereof, the front panel, the antireflection film serving as an optical filter may be laminated on the surface side (external side) or back side (display side) of the front plate.

### (Touch Panel)

The antireflection film of the invention can be applied to touch panels described in JP-A-5-127822, JP-A-2002-48913 and the like.

### (Organic EL Device)

The antireflection film of the invention can be used as a protective film of an organic EL device or the like.

When the antireflection film of the invention is used for an organic EL device or the like, details described in JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617, and JP-A-2002-056976 can be applied. It is preferred to use them with the details described in JP-A No-2001-148291, JP-A-2001-221916, and JP-A-2001-231443.

### [Various Characteristic Values]

Various measuring methods of the antireflection film of the invention and preferable characteristic values will next be described.

### [Reflectance]

Mirror reflectance and color are measured using a spectrophotometer “V-550” (trade name; product of JASCO) equipped with an adaptor “ARV-474” (trade name). Antireflection properties can be evaluated by measuring the mirror reflectance of an outgoing angle of −5° at an incident angle of 5° in a wavelength region of from 380 to 780 nm, and an average reflectance at from 450 nm to 600 nm is calculated.

### [Color]

The color of a polarizing plate using the antireflection film of the invention as its protective film can be evaluated by determining the color of specularly reflected light, that is, the L*, a*, b* values of the CIE 1976 L*a*b* color space, when CIE standard illuminant D₆₅ in a wavelength region of from 380 to 780 nm is incident on the antireflection film at an incidence angle of 5°.

The L*, a*, b* values preferably satisfy: 3≦L*≦20, −7≦a*≦7 and −10≦b*≦10, respectively. When the L*, a*, b* values are adjusted to fall within the above-described ranges, the color of the reflected light of from reddish purple to bluish purple, which has been a problem in a conventional polarizing plate, is reduced. Further, when they are adjusted to fall within the following ranges: 3≦L*≦10, 0≦a*≦5 and −7≦b*≦0, respectively, the above-described color is reduced greatly. In a liquid crystal device using such a polarizing plate, the color of it is neutral even if an external light of high brightness such as that from a fluorescent lamp in a room is slightly reflected and does not pose any problem. More specifically, a reddish color does not become too strong when a*≦7; a cyan color does not become too strong when a*≦−7. The a* within this range is therefore preferred. A bluish color does not become too strong when b*≦−7, and a yellowish color does not become too strong when b*≦−0. The b* within this range is therefore preferred.

The color uniformity of a reflected light can be calculated as a rate of color change in accordance with the below-described equation (3) based on the values a* and b* on the L*a*b* chromaticity diagram determined from the reflection spectrum of a reflected light at from 380 nm to 680 nm.

$$Rate of color change ( {a}^{*} ) = \frac{{a}_{max}^{*} - {a}_{min}^{*}}{{a}_{av}^{*}} \times 100 \\ Rate of color change ( {b}^{*} ) = \frac{{b}_{max}^{*} - {b}_{min}^{*}}{{b}_{av}^{*}} \times 100 \qquad Equation ( 3 )$$

In the equation, a*ₘₐₓ and a*ₘᵢₙ are the maximum value and minimum value of a*, respectively; b*ₘₐₓ and b*ₘᵢₙ are the maximum value and minimum value of b*, respectively; and a*ₐᵥ and b*ₐᵥ are average values of a* and b*, respectively. Rates of color change are each preferably 30% or less, more preferably 20% or less, most preferably 8% or less.

The antireflection film of the invention has ΔE_{w}, a change in color between before and after weather resistance test, of 15 or less, more preferably 10 or less, most preferably 5 or less. The ΔE_{w} falling within the above-described range is preferred because low reflection and reduction in color of reflected light can be accomplished simultaneously. For example, when such an antireflection film is laid as the outermost surface film of a display device, the color when an external light with high brightness is reflected slightly is neutral and a display image with good quality is provided.

The above-described change ΔE_{w} in color can be determined in accordance with the following equation (4):

ΔE_{w}=[(ΔL_{w})²+(Δa_{w})²+(Δb_{w})²]^{1/2} Equation (4):

wherein, ΔL_{w}, Δa_{w} and Δb_{w} are changes of L*, a* and b*, respectively between before and after weather resistance test.

### [Sharpness of Transmitted Image]

The sharpness of a transmitted image can be measured, using an optical comb having a slit width of 0.5 mm in an image clarity meter (“ICM-2D”, trade name; product of Suga Test Instruments) in accordance with JIS K-7105.

The antireflection film of the invention preferably has sharpness of a transmitted image of 60% or greater. The sharpness of a transmitted image is generally an index representing the degree of blurring of an image produced through a film. When this value is greater, the image viewed through the film becomes sharper and clearer. The sharpness of a transmitted image is preferably 70% or greater, more preferably 80% or greater.

### [Surface Roughness]

The central line average roughness (Ra) of the antireflection film of the invention can be measured in accordance with JIS B-0601.

### [Haze]

The haze of the antireflection film of the invention is determined automatically as haze=(diffused light/total transmitted light)×100(%) measured using a turbidimeter “NDH-101DP” (trade name; product of Nippon Denshoku Industries).

The antireflection film of the invention has preferably haze of 1.5% or less, more preferably 1.2% or less, most preferably 1.0% or less.

### [Goniophotometer Scattering Intensity Ratio]

A scattered light profile of the antireflection film was measured over all directions using a goniophotometer “GP-5” (trade name; product of Murakami Color Research Laboratory) by disposing the film perpendicular to incident light. It can be determined from the intensity of scattered light at an output angle of 300 with respect to the intensity of light at an output angle of 0°.

### [Evaluation on Steel-Wool Scratch Resistance]

The result of rubbing test using “Rubbing tester” under the following conditions can be used as an index of scratch resistance.

Environmental conditions for evaluation: 25° C., 60% RH Rubbing tool: Steel wool (Grade No. 0000, product of Nippon Steel Wool) is wound around the rubbing tip (1 cm×1 cm) of a tester to be brought into contact with a sample, and is fixed with a band.

Moving distance (one-way): 13 cm

Rubbing speed: 13 cm/sec

Load: 500 g/cm², and 200 g/cm²

Tip contact area: 1 cm×1 cm

Number of rubbing times: 10 reciprocations.

Evaluation is performed by applying oil black ink to the back side of the sample subjected to the rubbing test, visually observing scratches of the rubbed portion in reflected light and observing a difference in reflected light intensity between the rubbed portion and another portion.

### (Evaluation of Scratch Resistance Caused by Rubbing with an Eraser)

The result of rubbing test using “Rubbing Tester” under the following conditions can be used as an index of scratch resistance.

Environmental conditions for evaluation: 25° C., 60% RH Rubbing tool: Plastic eraser (“MONO”, trade name; product of Tombow Pencil) is fixed to a rubbing tip (1 cm×1 cm) of a tester to be brought into contact with a sample.

Moving distance (one-way): 4 cm

Rubbing speed: 2 cm/second

Load: 500 g/cm²

Tip contact area: 1 cm×1 cm

Number of rubbing times: 100 reciprocations.

Oil black ink is applied to the back side of the sample subjected to rubbing test and scratches of the rubbed portion are visually observed in reflected light. Evaluation is carried out based on a difference in reflected light intensity between the rubbed portion and another portion.

### (Taber Test)

In a taber test in accordance with JIS K5400, the scratch resistance can be evaluated from the abrasion loss of the test piece after the test. The less the abrasion loss, the better.

### [Hardness]

### (Pencil Hardness)

The hardness of the antireflection film of the invention can be evaluated by a pencil hardness test in accordance with JIS K-5400. The pencil hardness is preferably 1H or greater, more preferably 2H or greater, most preferably 3H or greater.

### (Surface Elasticity)

The surface elasticity of the antireflection film of the invention is a value determined using a microhardness testing system “Fischerscope H100VP-HCU” (trade name; product of Fischer Instruments). Described specifically, a pressing depth of the antireflection film, within a range not exceeding 1 μm, under an adequate test load is measured by using an indenter of a quadrangular pyramid made of diamond (an angle between its opposite faces: 136°) and from the load and deformation upon removal of the load, its surface elasticity is determined.

### (Universal Hardness)

The surface hardness of the antireflection film can be determined also as universal hardness by using the above-described microhardness testing system. The universal hardness is a value determined by measuring the pressing depth under a test load of a quadrangular indenter and then dividing the test load by the surface area of an indentation, as calculated from the geometrical shape of the indentation which has appeared under the test load. It is known that there is a positive relation between the surface elasticity and universal hardness.

### [Test on Antifouling Property]

### (Decontamination Performance on Felt Pen Ink)

The antireflection film is fixed onto the surface of a glass surface with an adhesive, and three circles, each 5 mm in diameter, are drawn with a tip (fine) of a felt pen (black ink, “Makky Gokuboso” (trade name; product of ZEBRA) under the conditions of 25° C. and 60 RH %. After 5 seconds, the circles are wiped by moving a cloth (“Bemcot”, trade name; product of Asahi Kasei), which has been folded into ten plies, back and forth 20 times under a load enough to bent the pile of Bemcot cloth. The above-described procedures of drawing and wiping are repeated under the same conditions until the circles drawn with the felt pen can no longer be erased by wiping. The antifouling property can be evaluated by the number of times until the circles can no longer be erased by wiping.

The number of times until the circles can no longer be erased by wiping is preferably 5 or greater, more preferably 10 or greater.

It is also possible to draw a circle of 1 cm in diameter on a sample with “Magic Ink No. 700 (M700-T1 Black) gokuboso” (trade name) as a black felt pen, black out the circle, rub the circle with “Bemcot” 24 hours after it is left as it, and evaluate an antifouling property by whether “Magic Ink” can be wiped off or not.

### [Surface Tension]

In the invention, the surface tension of a coating solution constituting the functional layers such as low refractive index layer can be measured using a surface tensiometer {“KYOWA CBVP SURFACE TENSIOMETER A3”, trade name; product of Kyowa Interface Science} under the environment at 25° C.

### [Contact Angle]

A liquid droplet of 1.0 mm in diameter is formed at a needlepoint with pure water as a liquid under dry state (20° C., 65% RH) by using a contact angle meter [“CA-X”, trade name; product of Kyowa Interface Science] and it is brought into contact with the surface of the antireflection film to lay it thereon. The angle which is formed between the tangent line relative to the liquid surface and the surface of the antireflection film at a contact point between the antireflection film and the liquid and is present on the side containing the liquid is designated as a contact angle.

### [Surface Free Energy]

The surface energy can be determined according to a contact angle method, a wet heat method or an adsorption method as described in Fundamentals and Applications of Wetting (published by Realize, Dec. 10, 1989). In the film of the invention, use of a contact angle method is preferred. Described specifically, two different solutions whose surface energy is known are added dropwise to a cellulose acylate film. The angle between a tangent line to the liquid drop and the film surface and present on the side including the liquid drop at the intersection made by the surface of the liquid drop and the film surface is defined as a contact angle. From the contact angle, the surface energy of the film can be calculated.

The surface free energy (γs^{v}: unit, mN/m) of the antireflection film of the invention is defined by a value γS^{v} (=γS^{d}+γS^{h}), that is, the sum of γS^{d} and γS^{h} determined according to the below-described simultaneous equations (a) and (b) {Equation (5)} from the respective contact angles θ_{H20} and θ_{CH2I2} of pure H₂O and methylene iodide (CH₂I₂) experimentally determined on the antireflection film with reference to D. K. Owens, J. Appl. Polym. Sci, 13, 1741 (1969), and it represents the surface tension of the antireflection film. When the γSᵥ is smaller and the surface free energy is lower, the film has higher repellency and therefore is usually excellent in antifouling property.

1+cos θ_{H2O}=2√γS^{d}(√γ_{H2O}^{d}/γ_{H2O}^{v})+2√γS^{h}(√γ_{H2O}^{h}/γ_{H2O}^{v}) (a)

1+cos θ_{CH2I2}=2√γS^{d}(√γ_{CH2I2}^{d}/γ_{CH2I2}^{v})+2{√γS^{h}(√γ_{CH2I2}^{h}/γ_{CH2I2}^{v}) (b)

γ_{H2O}^{d}=21.8, γ_{H2O}=51.0, γ_{H2O}^{v}=72.8, γ_{CH2I2}=49.5, γ_{CH2I2}=1.3 and γ_{CH2I2}^{v}=50.8

The contact angle is determined by controlling the humidity of the antireflection film for 1 hour or greater under the conditions of 25° C. and 60% RH, adding a liquid drop of 2 μL dropwise to the film by using an automatic contact angle meter [“CA-V150”, trade name; product of Kyowa Interface Science] and then measuring the contact angle 30 seconds after the dropwise addition.

The antireflection film of the invention has surface free energy of preferably 25 mN/m or less, especially preferably 20 mN/m or less.

### [Curl Degree]

The curl degree is measured using a curl measuring plate as described in Method A of JIS K-7619-1988 “Method for measuring the curl of a photographic film”.

Measurement is performed at 25° C. and 60% RH, while controlling the humidity for 10 hours.

The antireflection film of the invention has a curling degree, represented by the below-described equation (6), falling within a range of from −15 to +15, more preferably from −12 to +12, still more preferably from −10 to +10. The measuring direction of the curl in a sample is a traveling direction of the substrate when application is carried out in the web form.

Curling degree=1/R Equation (6):

wherein, R represents the radius of curvature (m).

This curling degree is an important property and the film provided with this property is free from cracks or peeling during the treatment for preparation, for processing or at the market. The curling degree is preferred when it falls within the above-described range and is as small as possible. The curling degree with “+” means that the disposed side of the film is on the inside of the curvature, while the curling degree with “−” means that the disposed side of the film is on the outside of the curvature.

In the film of the invention, an absolute value of a difference between the curling degree when only the relative humidity is changed to 80% and that when only the relative humidity is changed to 10% as measured in accordance with the above-described curl measuring method is preferably from 0 to 24, more preferably from 15 to 0, most preferably from 8 to 0. This property relates to handling property, peeling or cracks when the film is adhered under various humidity conditions.

### [Evaluation of Adhesion]

The adhesion between layers of the antireflection film, or between support and coated layer can be evaluated in the following manner.

A utility knife is used to cut 11 vertical lines and 11 horizontal lines with intervals of 1 mm on the surface of the side of the antireflection film having a coated layer, thereby making 100 squares in total. A polyester adhesive tape (“No. 31B”, trade name; product of Nitto Denko) is press bonded to the resulting film. After the film is allowed to stand for 24 hours, peeling test is performed at the same position three times in repetition. Whether the tape is peeled or not is visually observed. It is preferred that the number of squares in which peeling occurred is 10 or less, more preferably 2 or less, of the 100 squares.

### [Fragility Test (Crack Resistance)]

Crack resistance is an important property to avoid occurrence of crack defects during application, processing or cutting of the antireflection film, application of an adhesive, or attachment of the film to various substances.

A sample of the antireflection film is cut into a piece of 35 mm×140 mm. After the sample is allowed to stand for 2 hours under the conditions of 25° C. and 60% RH, the sample is curled into a cylindrical form and the diameter of curvature at which cracks start to appear is measured, by which the crack resistance on the film surface can be evaluated.

The crack resistance of the film of the invention is preferably 50 mm or less, more preferably 40 mm or less, most preferably 30 mm or less in terms of a curvature diameter at which cracks occur when the film is curled with the coated layer side as outside. The film preferably has no cracks at the edge thereof or has a crack length less than 1 mm on average.

### [Surface Resistance]

The surface resistance of the film of the invention is measured under the conditions of 25° C. and 60% RH by using an ultra high insulation resistance/microammeter (“TR8601” trade name; product of Advantest). A common logarithm of the surface resistance (Ω/□) was determined to calculate log SR.

### [Dust Removing Property]

The antireflection film of the invention is adhered to a monitor and dusts (fiber dusts from bedding or clothes) are sprinkled on the surface of the monitor. The dust removing property is evaluated by wiping off the dusts with a cleaning cloth.

The film permitting complete removal by wiping six times is preferred, and that permitting complete removal by wiping within three times is more preferred.

### [Drawing Performance of Liquid Crystal Device]

Evaluation method of the characteristics of the antireflection film of the invention placed on a display device and their preferred states will next be described.

A polarizing plate on the viewer side of a liquid crystal device “TH-15TA2” (trade name; product of Matsushita Electric Industrial) using a TN liquid crystal cell is peeled and instead of it, the antireflection film or polarizing plate of the invention is attached so that the coated surface is disposed on the viewer side and a transmission axis of the polarizing plate coincides with that of the polarizing plate originally attached to the device. Below-described various characteristics can be evaluated by visually observing, from various viewing angles, the liquid crystal device in the black display mode in a light room with a luminance of 500 Lx.

### (Evaluation of Unevenness and Color of a Drawn Image)

The unevenness or color change of a drawn image in the black display mode (L1) is visually observed by a plurality of observers by using a measuring apparatus (“EZ-Contrast 160D”, trade name; product of ELDIM).

The display device is preferred when not greater than three of ten observers recognize unevenness, difference in color between left and light images, color change due to temperature or humidity, or white blurring and is more preferred when no one recognizes it.

Reflection of external light is performed using a fluorescent lamp and a change in reflection is relatively evaluated visually.

### (Light Leakage in Black Display)

The percent light leakage in the black display mode in an azimuth direction of 450 and a polar angle direction of 70° from the front of the liquid crystal device is measured. The percent light leakage is preferably 0.4% or less, more preferably 0.1% or less.

### (Contrast, Viewing Angle)

With regard to the contrast and viewing angle, a contrast ratio and viewing angle (width of angle range permitting a contrast ratio of 10 or greater) in a horizontal direction (a direction perpendicular to the rubbing direction of a cell) can be analyzed using a measuring apparatus “EZ-Contrast 160D” (trade name; product of ELDIM).

### EXAMPLES

The invention will hereinafter be described more specifically based on Examples. It should however be borne in mind that the present invention is not limited to or by them.

### <Preparation of Antireflection Film>

[Preparation of Coating Solution for Forming Each Layer]

### [Preparation of Sol Solution (a-1)]

In a 1000-mL reaction vessel equipped with a thermometer, nitrogen inlet tube and dropping funnel, 187 g (0.80 mole) of 3-acryloxyoxypropyltrimethoxysilane, 27.2 g (0.20 mole) of methyltrimethoxysilane, 320 g (10 moles) of methanol and 0.06 g (0.001 mole) of potassium fluoride (KF) were charged. Under stirring, 15.1 g (0.86 mole) of water was added dropwise to the resulting solution at room temperature. After completion of the dropwise addition, the reaction mixture was stirred at room temperature for 3 hours, followed by stirring under heat for 2 hours under reflux of methanol. The low boiling point components are then distilled off under reduced pressure and the residue was filtrated to prepare 120 g of a sol solution (a-1).

As a result of GPC analysis of the resulting substance, it had a mass average molecular weight of 1500 and, of the components having monomer units equal to or greater in number than those of the oligomer component, 30 mass % of them had a molecular weight of from 1000 to 20000. As a result of ¹H-NMR, the substance thus obtained had a structure represented by the following formula:

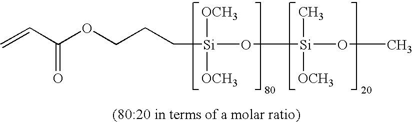

The condensation ratio α as a result of ²⁹Si-NMR measurement was 0.56. These analysis results have revealed that the silane coupling agent sol thus obtained is composed mainly of a linear structure. Further, analysis by gas chromatography has revealed that the remaining ratio of the acryloxypropyltrimethoxysilane used as a raw material was 5 mass % or less.

### [Preparation of Sol Solution (b-1)]

In a reaction vessel equipped with a stirrer and a reflux condenser, 119 parts by mass of methyl ethyl ketone, 101 parts by mass of 3-acryloyloxypropyltrimethoxysilane “KBM-5103” (trade name; product of Shin-Etsu Chemical), and 3 parts by mass of diisopropoxyaluminum ethyl acetoacetate were added and mixed. To the resulting mixture was added 30 parts by mass of ion exchanged water. After they were reacted at 60° C. for 4 hours, the reaction mixture was cooled to room temperature, whereby the sol solution (b-1) was prepared.

It has been found that the sol solution (b-1) had a mass average molecular weight of 1600 and, of the components having monomer units equal to or greater in number than those of the oligomer component, 100 mass % of them had a molecular weight of from 1000 to 20000. Further, analysis by gas chromatography has revealed that no acryloyloxypropyltrimethoxysilane used as the raw material remained. The resulting sol solution (b-1) had an SP value of 22.4.

### [Preparation of Coating Solution for Hard Coat Layer]

TABLE 2

| | | HC-1 | HC-2 | HC-3 | HC-4 | HC-5 | HC-6 | HC-7 | HC-8 | HC-9 | HC-10 |
|---|---|---|---|---|---|---|---|---|---|---|---|
| Binder | DPHA | 4.45 | 4.45 | 150 | — | 135 | — | — | 82 | — | — |
| | PETA | 40.1 | 40.1 | — | — | — | 50 | 50 | — | 285 | 285 |
| | “DeSolite Z7526” (containing silica) | — | — | — | 347 | — | — | — | — | — | — |
| | “DeSolite Z7401” (containing silica) | — | — | — | — | — | — | — | 195 | — | — |
| Particles | “MEK-ST” (silica particles) | — | 101 | 333 | — | 300 | — | — | — | — | — |
| | (30 mass %) | | | | | | | | | | |
| | Aggregating silica (secondary | — | — | — | — | — | — | — | — | 1.7 | 1.7 |
| | aggregation size: 1.5 μm) | | | | | | | | | | |
| | “SX-350” Crosslinked | — | — | — | — | — | 1.7 | 1.7 | 1.7 | — | — |
| | polystyrene particles (30 | | | | | | | | | | |
| | mass %) | | | | | | | | | | |
| | Crosslinked acryl/styrene | — | — | — | — | — | 13.3 | 13.3 | — | — | — |
| | particles (30 mass %) | | | | | | | | | | |
| Initiator | “Irgacure 184” | 1.34 | 1.34 | 7.5 | — | 6.75 | 2 | 2 | — | 15 | 15 |
| | “Irgacure 907” | 0.24 | 0.24 | — | — | — | — | — | — | — | — |
| Leveling | “FP-132” | 0.08 | 0.08 | — | — | — | 0.75 | 0.75 | — | — | — |
| agent | “R-30” | — | — | — | — | — | — | — | — | 0.5 | 0.5 |
| Silane | “KBM-5103” | — | — | — | — | — | 10 | — | — | — | — |
| coupling | Sol solution (a-1) | — | — | — | — | 25 | — | — | 25.8 | 25.8 | — |
| agent | | | | | | | | | | | |
| Solvent | Methyl ethyl ketone | — | — | 152 | 201.5 | 170 | — | — | 184 | — | — |
| | Methyl isobutyl ketone | 38 | 38 | — | — | — | — | — | — | 175 | 175 |
| | Cyclohexanone | 16.1 | 16.1 | 103 | 201.5 | 88 | — | — | 184 | — | — |
| | Toluene | — | — | — | — | — | 38.5 | 38.5 | — | — | — |

The coating solutions for forming a hard coat layer HC-1 to HC-10 were prepared in accordance with the above-described table. The numerals in parentheses indicate mass (g).

PETA: mixture of pentaerythritol triacrylate and pentaerythritol tetraacrylate [product of Nippon Kayaku].

DPHA: mixture of dipentaerythritol hexaacrylate and dipentaerythritol pentaacrylate [product of Nippon Kayaku]

“DeSolite Z7526” (trade name): commercially available silica-containing UV curable hard coat solution, solid concentration: 72 mass %, silica content: 38 mass %, average particle size: 20 nm [product of JSR]

“Desolite Z7401” (trade name): commercially available silica-containing UV curable hard coat solution, solid concentration: 70.1 mass %, silica content: 35 mass %, average particle size: 22 nm [product of JSR]

“MEK-ST” (trade name): silica sol, average particle size: 15 nm, solid concentration: 30 mass % [product of Nissan Chemical]

Monodisperse silica: “SEAHOSTAR KE-P 150” (trade name), particle size: 1.5 μm [product of Nippon Shokubai]

Aggregating silica: secondary aggregation size: 1.5 μm (primary particle size: several tens nm) [product of Nihon Silica]

“SX-350” (trade name): crosslinked polystyrene particles having an average particle size of 3.5 μm (refractive index: 1.60), 30 mass % toluene dispersion [product of Soken Chemical & Engineering], used after dispersion for 20 minutes at 10000 rpm in a Polytron homogenizer

Crosslinked acryl-styrene particles: average particle size: 3.5 μm (refractive index: 1.55), 30 mass % toluene dispersion [product of Soken Chemical & Engineering]

“Irgacure 184” (trade name): polymerization initiator [product of Ciba Specialty Chemicals]

“Irgacure 907” (trade name): polymerization initiator [product of Ciba Specialty Chemicals]

“FP-132” (trade name): fluorine surface modifier having the below-described formula:

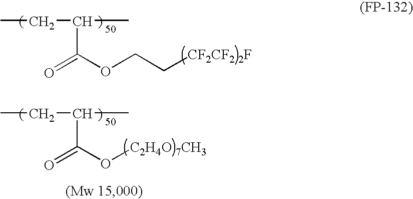

Fluorine leveling agent “R-30” (trade name): product of Dainippon Ink & Chemicals (commercially available product)

“KBM-5103” (trade name): silane coupling agent, 3-acryloyloxypropyltrimethoxysilane [product of Shin-Etsu Chemical]

Each solution obtained by thorough mixing was filtered through a filter made of polypropylene and having a pore size of 30 μm, whereby preparation of coating solutions HC-1 to HC-10 for forming hard coat layer was completed.

### (Formation of Hard Coat Layer)

By using a slot die coater shown in FIG. 1 of JP-A-2003-211052, a triacetylcellulose film (“TAC TD80U” (trade name) product of Fujifilm) having a thickness of 80 μm was unwound in a roll form and the coating solutions HC-1 to HC-10 for forming hard coat layer were each applied to give a coating amount of 16 cm³/m². After drying at 30° C. for 15 seconds and at 90° C. for 20 seconds, the coated layer was cured by exposure to ultraviolet light at 50 mJ/cm² by using an air-cool metal halide lamp (product of EYEGRAPHICS) of 160 W/cm under nitrogen purging. Thus, optical films respectively having hard coat layers having a thickness of from 2.5 to 6.0 μm were prepared and taken up.

In a similar manner except that the silica particles added to HC-2 were replaced with “CS-60 IPA” (trade name; product of Catalysts & Chemicals), a hollow silica dispersion having a refractive index of 1.31, average particle size of 60 nm, a shell thickness of 10 nm, solid concentration of 18.2% and hollow silica sol surface-modified with “KBM-5103” (surface modification ratio: 30 mass % relative to silica), an optical film having a hard coat layer HC-11 was prepared. In addition, an optical film having a hard coat layer was prepared in a similar manner to that employed for the preparation of HC-9 except that the amount of aggregating silica added to the hard coat layer was changed.

### [Preparation of Coating Solution for Forming Low Refractive Index Layer]

The coating solutions LN-1 to LN-10 for forming low refractive index layer were prepared in accordance with the below-described table. The numerals in the table indicate parts by mass.

TABLE 3

| | | LN-1 | LN-2 | LN-3 | LN-4 | LN-5 | LN-6 | LN-7 | LN-8 | LN-9 | LN-10 |
|---|---|---|---|---|---|---|---|---|---|---|---|
| Fluorine- | B-1 | 53 | 53 | 52.1 | 52.1 | 52.1 | 55.6 | 56.5 | 55.6 | — | — |
| containing | P-3 | — | — | — | — | — | — | — | — | 7.51 | 7.51 |
| binder | | | | | | | | | | | |
| Binder | Sot (b-1) | — | 2.58 | 2.58 | 2.58 | 2.58 | 1.92 | 1.88 | 1.92 | 0.95 | 0.95 |
| Particles | “MEK-ST” | — | — | 5.57 | — | — | — | — | — | — | — |
| | “MEK-ST-L” | — | — | — | 5.57 | 5.57 | 5.57 | 5.57 | 5.57 | 6.12 | 5.0 |
| | “SX-350” Crosslinked | — | — | — | — | — | — | — | — | — | 1.12 |
| | polystyrene particles (30 | | | | | | | | | | |
| | mass %) | | | | | | | | | | |
| Initiator | 1C-1 Compound solution | — | — | 2.82 | 2.82 | 2.82 | 2.08 | 1.73 | 2.08 | 0.05 | 0.05 |
| | “MP-triazine” | — | — | — | — | — | — | — | — | 0.09 | 0.09 |
| Additive | “RMS-033” | — | — | — | — | — | — | — | — | 2.75 | 2.75 |
| | Compound b-14 in Table 1 | — | — | — | — | — | — | — | 0.07 | — | — |
| Solvent | Methyl ethyl ketone | 44.2 | 41.6 | 34.1 | 34.1 | 34.1 | 32 | 31.5 | 32 | 75.1 | 75.1 |
| | Cylohexanone | 2.83 | 2.83 | 2.83 | 2.83 | 2.83 | 2.83 | 2.83 | 2.83 | 7.51 | 7.51 |
| | Total | 100 | 100 | 100 | 100 | 100 | 100 | 100 | 100 | 100 | 100 |

Each coating solution was filtered through a filter made of polypropylene and having a pore size of 1 μm, whereby a coating solution (LN-1 to LN-10) for forming a low refractive index layer was prepared.

Compounds used for the preparation of the each coating solution will next be described.

‘B-1’: A compound prepared by dissolving 80 g of a fluorine-containing thermosetting polymer disclosed in JP-A-11-189621 and Example 1, 20 g of Cymel 303 (produced by Nihon Cytec Industries Inc.) as a curing agent, and 2.0 g of Catalyst 4050 (produced by Nihon Cytec Industries Inc.) as a curing catalyst in methylethylketone so as to be 6%.

“JTA-113”, (trade name): A thermally crosslinkable fluorine-containing polymer having a silicon moiety, refractive index: 1.44, solid concentration: 6%, solvent: methyl ethyl ketone, the solid content composed of 78 mass % of a thermally crosslinkable fluorine-containing polymer having a silicon moiety, 20 mass % of a melamine crosslinking agent and 2 mass % of a paratoluenesulfonate salt; product of JSR)

“P-3”: fluorine-containing copolymer (P-3) as described in JP-A-2004-45462, mass average molecular weight of about 50000, solid concentration: 23.8 mass %, solvent: methyl ethyl ketone

“MEK-ST” (trade name): silica particle dispersion, average particle size: 15 nm, solid concentration: 30 mass %, dispersing solvent: methyl ethyl ketone, product of Nissan Chemical

“MEK-ST-L” (trade name): silica particle dispersion, average particle size: 45 nm, solid concentration: 30 mass %, dispersing solvent: methyl ethyl ketone, product of Nissan Chemical.

“1C-1 Compound solution”: solid concentration: 2 mass %, solvent: methyl ethyl ketone

“MP-triazine” (trade name): photopolymerization initiator, product of Sanwa Chemical

“RMS-033” (trade name): reactive silicone resin, product of Gelest.

### (Formation of Low Refractive Index Layer-1)

After formation of each hard coat layer of the invention, each of the coating solutions LN-1 to LN-8 for forming a low refractive index layer was wet applied thereto by a bar coater so that the low refractive index layer would have a dry film thickness of 95 nm. The resulting coating was dried at 120° C. for 150 seconds and then at 100° C. for 8 minutes, and exposed to ultraviolet light at an irradiation dose of 110 mJ/cm² by using a 240 W/cm air cooled metal halide lamp (product of Eyegraphics) in the atmosphere having an oxygen concentration adjusted to 100 ppm by nitrogen purging, whereby the low refractive index layer was formed and taken up.

### (Formation of a Low Refractive Index Layer-2)

After formation of each hard coat layer of the invention, the coating solutions LN-9, LN-10 for forming a low refractive index layer was wet applied thereto by a die coater so that the low refractive index layer would have a dry film thickness of 95 nm. The resulting coating was dried at 120° C. for 70 seconds, and exposed to ultraviolet light at an irradiation dose of 400 mJ/cm² by using a 240 W/cm air cooled metal halide lamp (product of Eyegraphics) in the atmosphere having an oxygen concentration adjusted to 100 ppm by nitrogen purging, whereby a low refractive index layer was formed and taken up.

In similar manners to those employed for the formation of low refractive index layer-1 and the formation of low refractive index layer-2 except that the MEK-ST and MEK-ST-L added to LN-3 and LN-9, respectively were replaced with “CS-60 IPA”: (trade name; product of Catalysts & Chemicals), a hollow silica dispersion having a refractive index of 1.31, average particle size of 60 nm, a shell thickness of 10 nm and solid concentration of 18.2%, and hollow silica sol surface-modified with “KBM-5103” (surface modification ratio: 30 mass % relative to silica), low refractive index layers LN-11 and LN-12 were prepared, respectively.

Further, in a similar manner to that employed for the formation of low refractive index layer-2 except for the use of conductive fine particles A1 and A2, which had been prepared in the below-described synthesis process, instead of the hollow silica dispersion of LN-12, low refractive index layers LN-13 and LN-14 were formed.

### Synthesis Example of Particles

### Synthesis Example 1

### [Synthesis of Hollow Conductive Fine Particles A-1 Having Fine SiO₂ Particles Bound to Ultrafine Au Particles]

To 200 ml of MEK (methyl ethyl ketone) were added 39 g of dispersion, in IPA (isopropyl alcohol), of hollow fine silica particles (prepared in accordance with Preparation Example 4 of JP-A-2002-79616; an average particle size: 40 nm, shell thickness: about 10 nm, refractive index of silica particles: 1.31, silica concentration: 20 mass %), 3 ml of 3-mercaptopropyltrimethoxysilane and 15 mg of aluminum isopropoxide and they were mixed. To the resulting mixture was added 3 ml of water further, followed by heating to 60° C. Stirring was performed for 4 hours to cause reaction and to the reaction mixture was then added a solution obtained by dissolving 8.4 g of gold (III) chloride acid tetrahydrate in 80 ml of MEK. To the resulting solution was added 15 ml of hydroxyacetone and the mixture was stirred for 30 minutes. The reaction mixture was then cooled to room temperature and the dispersion thus obtained was analyzed by TEM and XRD. As a result, it was found that ultrafine Au particles having a particle size of from 3 to 5 nm were bound to all the surfaces of the hollow fine silica particles.

A mass ratio of Au to silica (SiO₂) was 0.62 and a powder specific resistance of conductive fine particles was 90 Ω·cm.

The powder specific resistance (Ω·cm) was determined by molding sample powder under a pressure of 9.8 Mpa (100 kg/cm²) into a columnar powder molding (diameter: 18 mm, thickness: 3 mm), measuring direct-current resistance of the molding and calculating in accordance with the following equation.

Powder specific resistance (Ω·cm)=DC resistance (Ω)×2.54 (cm²)/0.3 (cm)]

### Synthesis Example 2

### [Synthesis of Hollow Conductive Fine Particles A-2 Having Fine SiO₂ Particles Covered with Antimony Oxide]

### [Preparation of Hollow Silica Fine Particles (C-1)]

A mixture of 100 g of a silica sol having an average particle size of 5 nm and an SiO₂ concentration of 20 wt. % and 1900 g of pure water was heated to 80° C. The resulting mother liquid has a pH of 10.5. To the mother liquid were added 9000 g of a 1.17 wt. % aqueous sodium silicate solution as SiO₂ and 9000 g of a 0.83 wt. % aqueous sodium aluminate solution as Al₂O₃ simultaneously. During the addition, the temperature of the reaction mixture was kept at 80° C. The pH of the reaction mixture increased to 12.5 just after addition and underwent no substantial change after that. After completion of the addition, the reaction mixture was cooled to room temperature and washed through a ultrafiltration membrane to prepare a primary particle dispersion of SiO₂.Al₂O₃ having a solid concentration of 20 wt. %.

To 500 g of the resulting primary particle dispersion was added 1700 g of pure water, followed by heating to 98° C. While keeping the temperature, 53200 g of ammonium sulfate having a concentration of 0.5 wt. % was added. Then, 3000 g of an aqueous sodium silicate solution having a concentration of 1.17 wt. % and 9000 g of an aqueous sodium aluminate solution having a concentration of 0.5 wt. % were added as SiO₂ and Al₂O₃, respectively, whereby a dispersion of composite fine oxide particles (1) were prepared.

To 500 g of a dispersion of composite fine oxide particles (1) having a solid concentration adjusted to 13 wt. % by washing through a ultrafiltration membrane was added 1125 g of pure water. Concentrated hydrochloric acid (concentration: 35.5 wt. %) was added dropwise to the resulting mixture to adjust its pH to 1.0, followed by aluminum-removing treatment. While adding 10 L of an aqueous hydrochloric acid solution having pH 3 and 5 L of pure water, the aluminum salt dissolved in the dispersion was separated using a ultrafiltration membrane, whereby a dispersion of hollow silica fine particles (C-1) having a solid concentration of 20 wt. % was prepared.

The resulting hollow silica fine particles (C-1) had an average particle size of 58 nm, a MOₓ/SiO₂ (molar ratio) of 0.0097 and a refractive index of 1.30.

### [Preparation of Antimonic Acid]

In a solution obtained by dissolving 57 g of potassium hydroxide (product of Asahi Glass, purity: 85 wt. %) in 1800 g of pure water was suspended 111 g of antimony trioxide (product of Sumitomo Metal Mining, KN purity: 98.5 wt. %). The resulting suspension was heated to 95° C. An aqueous solution obtained by diluting aqueous hydrogen peroxide (product of Hayashi Pure Chemical, special grade, purity: 35 wt. %) with 110.7 g of pure water was then added to the suspension over 9 hours (0.1 mole/hr) to dissolve antimony trioxide therein, followed by maturation for 11 hours. After cooling, a 1000 g portion of the resulting solution was diluted with 6000 g of pure water and then subjected to deionization treatment through a cationic exchange resin (“pk-216”, trade name; product c of Mitsubishi Chemical). At that time, the solution had a pH of 2.1 and conductivity of 2.4 mS/cm.

To 400 g of a dispersion obtained by diluting the dispersion of hollow silica fine particles (C-1) to a solid concentration of 1 wt. % was added 40 g of antimonic acid having a solid concentration of 1 wt. %. The resulting mixture was stirred at 70° C. for 11 hours and then, concentrated through a ultrafiltration membrane, whereby an antimony-oxide-covered silica fine particle (P-1) dispersion having a solid concentration of 20 wt. % was prepared. The antimony-oxide-covered silica fine particles had an average particle size of 60 nm and the thickness of the antimony oxide covering layer was about 2 nm.

To 100 g of the antimony-oxide-covered silica fine particle dispersion were added 300 g of pure water and 400 g of methanol. The resulting mixture was mixed with 3.57 g of ethyl orthosilicate (having an SiO₂ concentration of 28 wt. %), followed by stirring at 50° C. for 15 hours to prepare an antimony-oxide-covered silica fine particle (A-1) dispersion having a silica covered layer formed therein. The resulting dispersion was subjected to solvent substitution with methanol and concentrated until its solid concentration became 20 wt. %. In a rotary evaporator, the solvent was replaced with isopropyl alcohol, whereby an isopropyl alcohol dispersion of silica fine particles having a concentration of 20 wt. % was prepared.

To 100 g of the isopropyl alcohol dispersion of the antimony-oxide-covered silica fine particles having the silica covered layer formed therein was added 0.73 g of a methacrylic silane coupling agent (“KBM-503”, trade name; product of Shin-Etsu Chemical). The resulting mixture was stirred under heat at 50° C. for 15 hours to form a silica covered layer, whereby a dispersion of surface-treated antimony-oxide-covered silica fine particles (A-2) was prepared.

A mass ratio of antimony oxide to silica (SiO₂) was 0.11. The conductive fine particles had a powder specific resistance of 1600 Ω·cm and refractive index of 1.41.

### [Evaluation of Antireflection Film Sample]

The following properties of the antireflection films thus obtained are evaluated. The results are shown in Table 3.

### [Mirror-Surface Reflectance]

An adapter “ARV-474” (trade name) was set on a spectrophotometer “V-550” (trade name; product of JASCO) and mirror reflectance at an output angle of 5° relative to an incident angle of 5° was measured in a wavelength range of from 380 to 780 nm. Then an average reflectance was calculated in the wavelength range of from 450 to 650 nm and the antireflection property was evaluated.

### (Pencil Hardness)

The pencil hardness was evaluated in accordance with JIS-K-5400.

After humidity conditioning of the antireflection film at 25° C. and 60% RH for two hours, a load of 500 g was applied with a test pencil having a hardness of from H to 5H as defined in JIS S-6006 and its pencil hardness was evaluated. The pencil hardness value highest among the values given to the film was employed as an evaluation value of pencil hardness.

OK: no scratches or one scratch in the evaluation at n=5

NG: three or more scratches in the evaluation at n=5.

### (Resistance to Rubbing with Steel Wool)

The scratches of the film formed by moving a steel wool #0000 back and forth ten times under the application of a load of 200 g/cm² were observed and were assessed using 5-point scale.

A: No scratches remained on the surface.

B: Almost invisible scratches remained on the surface slightly.

C: Some visible scratches remained.

D: Visible scratches remained markedly on the surface.

E: Peeling of the film occurred.

TABLE 4

| | Hard | Inorganic fine | Thickness | | Low | Inorganic fine | Average | | |
|---|---|---|---|---|---|---|---|---|---|
| | coat | particles in hard | of hard coat | Surface | refractive | particles in low | reflectance | Pencil | Steel wool |
| | layer | coat layer | layer (μm) | haze (%) | index layer | refractive index layer | (%) | hardness | resis-tance |
| Comp. | HC-1 | Not added | 2.5 | 0 | LN-1 | Not added | 2.81 | 2H | D |
| Ex. 1 | | | | | | | | | |
| Comp. | HC-1 | Not added | 2.5 | 21 | LN-7 | Added | 2.79 | 2H | D |
| Ex. 2 | | | | | | | | | |
| Comp. | HC-2 | Added | 6 | 4 | LN-1 | Not added | 2.8 | 3H | D |
| Ex. 3 | | | | | | | | | |
| Comp. | HC-2 | Added | 6 | 6 | LN-2 | Not added | 2.82 | 3H | D |
| Ex. 4 | | | | | | | | | |
| Ex. 1 | HC-2 | Added | 6 | 7 | LN-4 | Added | 2.79 | 3H | B |
| Ex. 2 | HC-2 | Added | 6 | 5 | LN-7 | Added | 2.8 | 3H | B |
| Ex. 3 | HC-2 | Added | 6 | 20 | LN-9 | Added | 2.79 | 3H | B |
| Ex. 4 | HC-3 | Added | 6 | 22 | LN-7 | Added | 2.79 | 3H | B |
| Ex. 5 | HC-4 | Added | 6 | 10 | LN-7 | Added | 2.79 | 3H | B |
| Ex. 6 | HC-5 | Added | 6 | 18 | LN-7 | Added | 2.79 | 3H | B |
| Comp. | HC-6 | Not added | 6 | 23 | LN-7 | Added | 2.79 | 2H | C |
| Ex. 5 | | | | | | | | | |
| Comp. | HC-7 | Not added | 6 | 25 | LN-7 | Added | 2.79 | 2H | C |
| Ex. 6 | | | | | | | | | |
| Ex. 7 | HC-8 | Added | 6 | 11 | LN-7 | Added | 2.79 | 3H | B |
| Ex. 8 | HC-9 | Added | 2.5 | 8 | LN-7 | Added | 2.79 | 3H | B |
| Ex. 9 | HC-10 | Added | 2.5 | 6 | LN-7 | Added | 2.79 | 3H | B |
| Ex. 10 | HC-10 | Added | 6 | 13 | LN-3 | Added | 2.79 | 3H | B |
| Ex. 11 | HC-10 | Added | 6 | 13 | LN-4 | Added | 2.8 | 3H | B |
| Ex. 12 | HC-10 | Added | 6 | 11 | LN-5 | Added | 2.81 | 3H | A |
| Ex. 13 | HC-10 | Added | 2.5 | 6 | LN-6 | Added | 2.78 | 3H | A |
| Ex. 14 | HC-10 | Added | 6 | 15 | LN-7 | Added | 2.8 | 3H | A |
| Ex. 15 | HC-10 | Added | 6 | 15 | LN-8 | Added | 2.81 | 3H | A |
| Ex. 16 | HC-10 | Added | 6 | 16 | LN-9 | Added | 2.8 | 3H | A |
| Ex. 17 | HC-10 | Added | 6 | 22 | LN-10 | Added | 2.82 | 3H | A |
| Ex. 18 | HC-10 | Added | 2.5 | 5 | LN-11 | Added | 1.5 | 3H | B |
| Ex. 19 | HC-10 | Added | 2.5 | 5 | LN-12 | Added | 1.5 | 3H | A |
| Ex. 20 | HC-2 | Added | 6 | 5 | LN-12 | Added | 1.51 | 3H | A |
| Ex. 21 | HC-11 | Added | 6 | 5 | LN-12 | Added | 1.51 | 3H | A |
| Ex. 22 | HC-2 | Added | 6 | 7 | LN-13 | Added | 1.52 | 3H | A |
| Ex. 23 | HC-2 | Added | 6 | 7 | LN-14 | Added | 1.53 | 3H | B |

As is apparent from Table 4, incorporation of an initiator and fine metal oxide particles in at least two layers having different structures makes it possible to prepare a film having excellent scratch resistance without losing a sufficient antireflective performance.

### Example 21

### <Preparation of Protective Film for Polarizing Plate>

A saponified solution was prepared by keeping a 1.5 mole/L aqueous sodium hydroxide solution at 50° C. In addition, a 0.005 mole/L dilute aqueous sulfuric acid solution was prepared.

The antireflection films prepared in Examples 1 to 20 were subjected to, on the surface of the transparent support on the side opposite to the low refractive index layer thereof, saponification treatment with the above-described saponification solution. The aqueous sodium hydroxide solution on surface of the transparent support was then washed off sufficiently with water. After washing with the above-described dilute aqueous sulfuric acid solution, the dilute aqueous sulfuric acid solution was then washed off sufficiently and the film, followed by enough drying at 100° C.

As a result of evaluation, the contact angle of water on the surface of the transparent support of the antireflection film on the side subjected to saponification treatment was 40° or less. In such a manner, a protective film for polarizing plate was prepared.

### [Fabrication of Polarizing Plate]

### [Preparation of Polarization Film]

A polyvinyl alcohol film [product of Kuraray] having a thickness of 75 μm was dipped for 5 minutes in an aqueous solution composed of 1000 parts by mass of water, 7 parts by mass of iodine and 105 parts by mass of potassium iodide to adsorb iodine to the film. The resulting film was monoaxially stretched at a draw ratio of 4.4 in a lengthwise direction in a 4 mass % aqueous boric acid solution, followed by drying under tension to prepare a polarization film.

With a polyvinyl alcohol adhesive, the saponified triacetyl cellulose surface of the antireflection film (protective film for polarizing plate) subjected to saponification treatment was adhered to one of the surfaces of the polarization film. A triacetyl cellulose film subjected to similar saponification treatment was adhered to the other surface of the polarization film with a similar polyvinyl alcohol adhesive.

### [Evaluation of Polarizing Plate on Display Device]

The polarizing plates of the invention thus prepared in Example 21 were each installed so that the antireflection film would be the outermost surface of a display. Transmission type, reflection type and semi-transmission type liquid crystal display devices in TN, STN, IPS, VA or OCB mode each had an excellent antireflection performance and was markedly excellent in visibility. The effect was particularly excellent in the display device in VA mode.

### Example 22

### [Fabrication of Polarizing Plate]

The surface of an optically compensatory film “Wide View Film SA12B” (trade name; product of Fujifilm) having an optically compensatory layer on a side opposite to the optically compensatory layer was saponified under similar conditions to those employed in Example 21.

With a polyvinyl alcohol adhesive, the saponified surface of each of the antireflection films (protective films for polarizing plate) prepared in Example 1 and Example 2 was adhered to one of the surfaces of the polarization film prepared in Example 21. To the other surface of the polarization film was adhered the surface of the saponified optically compensatory film, which was on a side opposite to the optically compensatory layer, with a similar polyvinyl alcohol adhesive.

### [Evaluation of Polarizing Plate on Display Device]

The polarizing plates of the invention thus prepared in Example 22 were each installed so that the antireflection film would be the outermost surface of a display. Transmission type, reflection type and semi-transmission type liquid crystal display devices in TN, STN, IPS, VA or OCB mode were each excellent in contrast in a light room, had a very wide viewing angle in any direction, were excellent in antireflection performance, and were markedly excellent in visibility and display quality compared with a liquid crystal display device equipped with a polarizing plate having no optically compensatory film. The effect was particularly excellent in the display device in VA mode.

The present invention makes it possible to produce an optical film or antireflection film having improved scratch resistance while maintaining a sufficient antireflective property. According to the production process of the present invention, such an optical film or antireflection film is available stably in high productivity and low cost. A display device equipped with the optical film, antireflection film or polarizing plate of the invention is characterized in that it has markedly high visibility with less reflection of external light or background.

The entire disclosure of each and every foreign patent application from which the benefit of foreign priority has been claimed in the present application is incorporated herein by reference, as if fully set forth.

What is claimed is:

1. An optical film, which comprises:
a transparent support; and
at least two layers each containing a cured product on or above the transparent support, the at least two layers comprising: a layer to be brought into contact with a surface of the transparent support; and an outermost layer of the optical film,
wherein the layer to be brought into contact with the surface of the transparent support contains a cured product of a below-described composition (I) and the outermost layer of the optical film is a layer containing a cured product of a below-described composition (II):
Composition (I): a composition comprising: a polyfunctional compound (a) having two or more ethylenically unsaturated groups; at least one of a photo-polymerization initiator and a thermo-polymerization initiator; and metal oxide particles,
Composition (II): a composition comprising: a binder polymer; a polyfunctional compound (b) having two or more ethylenically unsaturated groups; at least one of a photo-polymerization initiator and a thermo-polymerization initiator; and metal oxide particles.

2. The optical film according to claim 1,
wherein the metal oxide particles are at least one kind of particles selected from the group consisting of particles made of silicon dioxide, particles made of tin oxide, particles made of indium oxide, particles made of zinc oxide, particles made of zirconium oxide and particles made of titanium oxide.

3. The optical film according to claim 1,
wherein the metal oxide particles are aggregating particles, colloidal particles or hollow particles.

4. The optical film according to claim 2,
wherein the particles made of silicon dioxide are aggregating silica particles or colloidal silica particles.

5. The optical film according to claim 1,
wherein the metal oxide particles have conductivity.

6. The optical film according to claim 1,
wherein the metal oxide particles have a particle size of 1 nm or greater but not greater than 1 μm.

7. The optical film according to claim 1,
wherein the metal oxide particles are surface-modified with a compound having hydrolyzable silicon.

8. The optical film according to claim 1,
wherein the binder polymer is at least one of a heat curable fluorine-containing polymer and an ionizing-radiation curable fluorine-containing polymer.

9. The optical film according to claim 1,
wherein at least one of the composition (I) and the composition (II) further comprises light transmitting resin particles having an average particle diameter in a range of from 1 nm to 15 μm.

10. The optical film according to claim 1,
wherein the polyfunctional compound (b) in the composition (II) is at least one of a hydrolysate of an organosilane and a partial condensate thereof.

11. An antireflection film which is an optical film according to claim 1 having an antireflective function.

12. A polarizing plate, which comprises:
a pair of protective films; and
a polarization film between the pair of protective films,
wherein at least one of the pair of protective films is an optical film according to claim 1.

13. A display device, which comprises an optical film according to claim 1,
wherein the layer of the optical film containing the cured product of the composition (II) is disposed on a viewer side.

14. A process for producing an optical film comprising a transparent support and at least two layers each containing a cured product on or above the transparent support, the process comprising:
applying a below-described composition (I) to the transparent support as a layer to be brought into contact with a surface of the transparent support;
drying and then curing the composition (I) by at least one of a heating and an exposure to ionizing radiation in an atmosphere having an oxygen concentration of 3 vol. % or less; and
applying a below-described composition (II) as an outermost layer of the optical film;
drying and then curing the composition (II) by at least one of a heating and an exposure to ionizing radiation in an atmosphere having an oxygen concentration of 3 vol. % or less:
Composition (I): a composition comprising: a polyfunctional compound (a) having two or more ethylenically unsaturated groups; at least one of a photo-polymerization initiator and a thermo-polymerization initiator; and metal oxide particles,
Composition (II): a composition comprising: a binder polymer; a polyfunctional compound (b) having two or more ethylenically unsaturated groups; at least one of a photo-polymerization initiator and a thermo-polymerization initiator; and metal oxide particles.
